(19) United States
(12) Patent Application Publication
(10) Pub. No.: US 2026/0141895 A1
(43) Pub. Date: May 21, 2026

(54) INTELLIGENT INTERRUPTION HANDLING

(71) Applicant: Twilio Inc., San Fancisco, CA (US)

(72) Inventors: Daniel Jansson, San Francisco, CA (US); Nupur Vasudeo Dharwadkar, Sunnyvale, CA (US); Christer Jan Erik Fahlgren, San Francisco, CA (US); Christopher Feehan, San Francisco, CA (US); Brandon Joel Hawkins, Lafayette, CO (US); Austin Park, San Francisco, CA (US); Daniel Weijian Qian, Milpitas, CA (US)

(21) Appl. No.: 18/954,452

(22) Filed: Nov. 20, 2024

(51) Int. Cl. G10L 15/16

(52) U.S. Cl. CPC G10L 15/16

(57) ABSTRACT

Methods and systems for intelligently detecting and handling interruptions in voice-based AI conversations by analyzing audio input in real-time are disclosed. Audio input is received during an artificial intelligence (AI) voice interaction between a user and an AI assistant. The audio input is analyzed in real-time to determine whether the audio input represents an intended interruption of the AI assistant's speech. In response to determining the audio input represents an intended interruption, the AI assistant's speech is stopped and what portion of a response was actually spoken is tracked. Context awareness is maintained by storing information about the interrupted response to allow resuming from the point of interruption.

### TECHNICAL FIELD

The disclosed subject matter relates generally to the technical field of real-time conversational artificial intelligence systems and, in one specific embodiment, to methods and systems for intelligently detecting and handling interruptions in voice-based human-AI interactions to enable more natural conversational flow.

### BACKGROUND

Voice-based artificial intelligence systems have become increasingly prevalent in customer service and business communications, but current systems suffer from significant limitations that impact their effectiveness and user experience. These systems typically face challenges in handling the subtle nuances of real-time human conversation, leading to frustration and disengagement among users. Traditional voice AI solutions struggle with high latency issues that disrupt the natural flow of conversation, often buffering or delaying responses while waiting for complete processing of input. The accuracy with which intelligent assistants understand and respond to user intents is often hindered by the extensive training requirements of traditional AI systems, impacting both operational costs and the effectiveness of these systems in resolving interactions without escalating to human agents. Additionally, current text-to-speech implementations frequently struggle with proper intonation and pacing, particularly around punctuation and natural speech patterns, resulting in robotic-sounding outputs that fail to approximate human conversation patterns.

### BRIEF DESCRIPTION OF THE DRAWINGS

Some embodiments are illustrated by way of example and not limitation in the figures of the accompanying drawings.

FIG. 1 illustrates a network diagram depicting a system within which various example embodiments may be deployed, including client machines, API and web servers, and database servers connected through a network.

FIG. 2 illustrates a block diagram of service(s) 120 for implementing conversational AI capabilities, showing multiple integrated modules that work together to enable natural voice interactions.

FIG. 3 illustrates a pilot architecture for Conversational AI (LLM) Assistants showing the integration between end-customers, conversational relay adapters, and AI Assistant components.

FIG. 4 shows the division between platform-owned and customer-owned components in the system architecture, connected via websocket communication.

FIGS. 5A and 5B illustrate the latency breakdown for speech-to-text, language model processing, and text-to-speech conversion in the system.

FIG. 6 shows an example user interface for configuring and testing the system, including conversational relay settings and customer configurations.

FIG. 7 illustrates a comprehensive user interface for configuring and managing AI assistants within the system.

FIGS. 8A and 8B show expanded architectures of the system for voice interactions, introducing integration with unified profiles and marketplace components.

FIG. 9 illustrates a comprehensive end-to-end system that includes Conversational Intelligence and administrator roles.

FIGS. 10A and 10B illustrate the integration of Conversational Intelligence with the core Conversational AI (LLM) Assistants system.

FIG. 11 illustrates an end-to-end latency breakdown and data flow for AI Agents in the system.

FIG. 12 illustrates example end-to-end call flows for the system's BYOT implementation and AI Assistant integration.

FIG. 13 illustrates an example BYOT implementation and AI Assistant integration.

FIG. 14 shows an example table of parameters for configuring the system.

FIG. 15 is a sequence diagram illustrating an interaction between three components: the Caller, the platform (e.g., Twilio), and the websocket server.

FIG. 16 is a sequence diagram showing interactions between five components: the Caller, VTP, Conversational Relay, CustomerServer, and LLM.

FIG. 17 illustrates a block diagram depicting an example AI Assistant integration architecture, showing how the platform's components interact with customer applications and third-party services.

FIG. 18 illustrates a modified example architecture in comparison to FIG. 17, with key differences in how the platform interfaces with customer applications and handles AI processing.

FIG. 19 illustrates a comprehensive system architecture diagram showing the integration of multiple components for Conversational AI Assistants, organized into sections for Channels, Conversational Intelligence, Real-Time Domain, and Applications.

FIG. 20 illustrates example operations for implementing intelligent interruption handling in voice communications.

FIG. 21 illustrates example operations for implementing vocal tick recognition in voice communications.

FIG. 22 illustrates example operations for implementing low-latency streaming text tokens in voice communications.

FIG. 23 illustrates example operations for implementing adaptive pacing and intonation in voice communications.

FIG. 24 illustrates example operations for implementing websocket-based real-time communication in voice interactions.

FIG. 25 illustrates example operations for implementing flexible integration with multiple language models and voice AI providers.

FIG. 26 illustrates example operations for implementing context-aware conversation management in voice communications.

FIG. 27 is a block diagram illustrating a mobile device that can be used to access or interact with the system.

FIG. 28 is a block diagram of an example computer system on which methodologies described herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Voice-based artificial intelligence systems have become increasingly prevalent in customer service and business communications. Current systems often suffer from latency issues that disrupt the natural flow of conversation, leading to frustration and disengagement among users.

Traditional voice AI solutions face challenges in handling the subtle nuances of real-time human conversation, including interruptions, pacing, and emotional undertones.

Existing solutions typically treat all user sounds as interruptions, leading to unnecessary pauses and disruptions in communication flow.

When integrating with large language models (LLMs), current systems struggle with managing context and providing natural-sounding responses due to delays between receiving input and generating appropriate outputs. These delays can significantly impact the user experience, as traditional systems often buffer or delay responses while waiting for complete processing of input.

The accuracy with which intelligent assistants understand and respond to user intents is often hindered by the extensive training requirements of traditional AI systems. This impacts both operational costs and the effectiveness of these systems in resolving interactions without escalating to human agents.

Additionally, the integration of intelligent assistants across multiple communication channels and their ability to synchronize with real-time data streams remains complex, often slowing down deployment and limiting system responsiveness.

Current text-to-speech implementations frequently struggle with proper intonation and pacing, particularly around punctuation and natural speech patterns. This can result in robotic-sounding outputs that fail to approximate human conversation patterns.

Furthermore, existing systems often treat each user input as isolated, leading to repetitive or irrelevant responses that fail to maintain coherent context throughout an interaction.

Current AI voice assistants cannot handle interruptions gracefully, leading to unnatural and frustrating user experiences. Prior solutions either ignore interruptions completely or abruptly stop without context, resulting in disjointed conversations. Existing systems treat all user sounds as interruptions, causing unnecessary pauses that disrupt conversation flow. Traditional voice AI solutions lack the ability to detect whether a user actually meant to interrupt the AI or was simply acknowledging the conversation.

In example embodiments, an intelligent interruption handling feature of a system is disclosed to provide a technological solution to one or more technological problems in the prior art described herein. The system implements an intelligent interruption handling mechanism that detects when a user interrupts the AI's speech and stops the AI's response, tracks how much of the response was actually spoken, provides the ability to resume from the point of interruption if requested, uses an on-prem processor to handle voice-to-text locally and/or perform preprocessing before querying the LLM, implements algorithms to determine whether sounds are meant as interruptions or just acknowledgments, and/or maintains context awareness to track what portions of responses were actually communicated.

Current AI systems overreact to non-interruptive sounds like “hmm” or “uh-huh”, treating all user sounds as interruptions. This leads to unnecessary pauses and disruptions in the natural flow of conversation. Existing solutions lack the ability to distinguish between actual interruptions and vocal acknowledgments.

In example embodiments, a vocal tick recognition feature of a system is disclosed to provide a technological solution to one or more technological problems in the prior art described herein. The system analyzes audio input in real-time to categorize sounds as either meaningful interruptions or non-interruptive vocal ticks, continues AI speech without interruption when vocal ticks are detected, can identify user-specific patterns and build profiles to better recognize individual vocal habits, and/or uses machine learning to detect whether sounds indicate acknowledgment versus interruption intent.

Current systems suffer from high latency in AI voice responses, making conversations feel unnatural and slow. Traditional systems wait for complete responses before beginning speech synthesis, causing noticeable delays. There are inherent delays between LLM producing first tokens and completing full responses.

In example embodiments, low-latency streaming text tokens are used by a system to provide a technological solution to one or more technological problems in the prior art described herein. In example embodiments, the system implements real-time streaming of text tokens from the LLM as they're generated, intelligent buffering and chunking for optimal audio segmentation, an aspect in which the system begins processing and speaking initial words while continuing to receive and process the rest of the response, algorithms to identify when a “sayable” string is complete based on punctuation and context, and/or special handling of abbreviations and ambiguous punctuation cases.

Current AI voice assistants produce unnatural, robotic-sounding speech using fixed rules for pacing and intonation. Existing solutions fail to properly handle natural speech patterns around punctuation and pausing. Text-to-speech engines struggle with appropriate intonation for partial sentences or interrupted speech.

In example embodiments, low-latency streaming text tokens are used by a system to provide a technological solution to one or more technological problems in the prior art described herein.

In example embodiments, adaptive pacing and/or adaptive intonation features are included in a system to provide a technological solution to one or more technological problems in the prior art described herein. In example embodiments, the system includes logic to determine appropriate pausing and intonation based on punctuation and context, dynamic adaptation of speech output based on content context, intelligent chunking of text to maintain natural intonation patterns, sliding window approach to optimize intonation across word sequences, and/or an ability to insert natural pauses and breathing patterns.

Traditional request-response models for voice AI systems suffer from high latency and inefficiency. Prior solutions relied on HTTP polling or long-polling, which are resource-intensive and introduce delays.

In example embodiments, websocket-based real-time communication is included in a system to provide a technological solution to one or more technological problems in the prior art described herein. In example embodiments, the system utilizes websocket-based architecture for real-time, bi-directional communication, persistent connections for continuous data streaming, low-latency transmission of speech-to-text and text-to-speech data, efficient handling of large amounts of real-time data, and/or immediate streaming of audio data for processing as soon as user starts speaking

Existing voice AI solutions typically rely on a single LLM or voice AI provider, limiting customization options and potentially increasing costs. Current systems create vendor lock-in and lack flexibility in provider selection.

In example embodiments, a websocket-based real-time communication feature is included in a system to provide a technological solution to one or more technological problems in the prior art described herein.

In example embodiments, the system provides an integration capability with various LLMs and voice AI providers through a marketplace model, an ability to choose and switch between different providers for speech-to-text, text-to-speech, and language models, a modular, mix-and-match system for voice AI components, and/or potential cost savings through provider competition.

Many AI conversation systems lack coherence and contextual understanding, treating each user input as isolated. This leads to repetitive or irrelevant responses. Current systems fail to maintain context throughout conversations, particularly when handling interruptions or switching between different parts of a dialogue.

In example embodiments, a context-aware conversation management feature is included in a system to provide a technological solution to one or more technological problems in the prior art described herein. In example embodiments, the system maintains context throughout the conversation, including tracking what has been said, manages conversation flow with contextual awareness, enables more coherent and contextually appropriate responses, can reference previous parts of the conversation for relevant answers, and/or provides ability to track what portions of AI responses were actually communicated versus interrupted.

In example embodiments, methods and systems for intelligently detecting and handling interruptions in voice-based AI conversations by analyzing audio input in real-time are disclosed. Audio input is received during an artificial intelligence (AI) voice interaction between a user and an AI assistant. The audio input is analyzed in real-time to determine whether the audio input represents an intended interruption of the AI assistant's speech. In response to determining the audio input represents an intended interruption, the AI assistant's speech is stopped and what portion of a response was actually spoken is tracked. Context awareness is maintained by storing information about the interrupted response to allow resuming from the point of interruption.

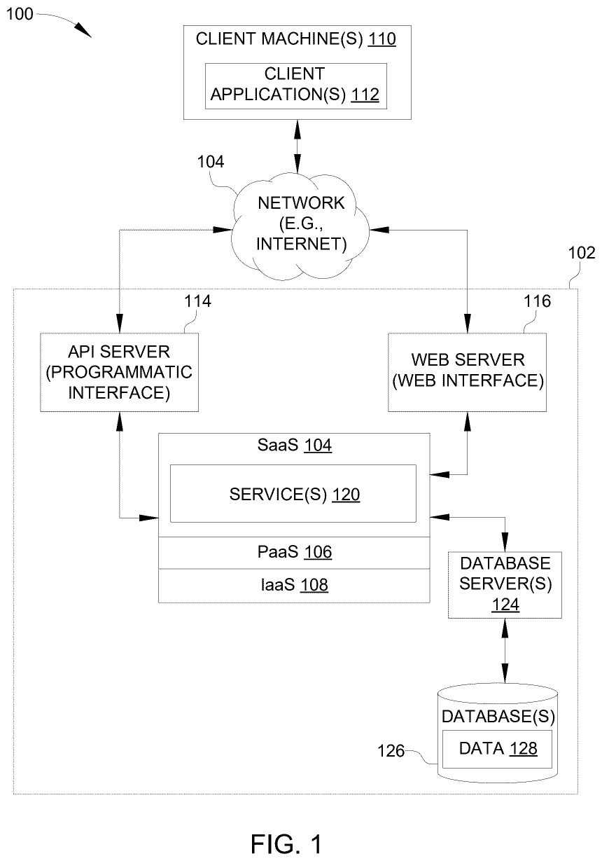

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The figure illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., service(s)) 120 are shown in the figure to form part of the networked system 102, in alternative embodiments, the applications 120 may form part of a service that is separate and distinct from the networked system 102.

Further, while the system 100 shown in the figure employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although the figure depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may access the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server application(s) and/or service(s) 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as the system's data items 128. In example embodiments, the system's data items may be any of the data items described herein.

Navigation of the networked system 102 may be facilitated by one or more navigation applications. For example, a search application (as an example of a navigation application) may enable keyword searches of data items included in the one or more database(s) 126 associated with the networked system 102. A client application may allow users to access the system's data 128 (e.g., via one or more client applications). Various other navigation applications may be provided to supplement the search and browsing applications.

The service(s) 120 shown in FIG. 1 may include one o more components or modules for implementing one or more of the technological solutions described herein. For example, the services may include a websocket client that establishes bi-directional websocket media connections with client applications and handles real-time streaming of audio data. The services may also include speech-to-text (STT) and text-to-speech (TTS) processing components that convert between audio and text with configurable parameters for language, voice selection, and speech models. An intelligent interruption handling component may analyze audio input to detect and manage user interruptions during AI responses. A text token streaming component may process and buffer text tokens from language models to enable low-latency responses. The services may further include components for adaptive pacing and intonation that analyze punctuation and context to generate natural-sounding speech output. A flexible integration layer may enable connections to multiple LLM and voice AI providers through a marketplace model. Additionally, the services may include components for maintaining conversation context and managing personalization through integration with user profiles and knowledge bases. These services can be accessed through both programmatic (API) and web interfaces as shown in FIG. 1. In example embodiments, the underlying infrastructure is provided through PaaS and IaaS layers.

The data 128 stored in the databases may include one or more types of information related to one or more of the various technological solutions described herein. For example, the data 128 may include one or more of records of user-specific vocal patterns and ticks identified during conversations, historical data about which portions of AI responses were actually spoken versus interrupted, timestamps and/or durations of interruptions for analysis and improvement, streaming text tokens from LLM responses with metadata about timing and chunking, speech-to-text transcriptions and/or text-to-speech conversion data, punctuation and/or context markers used for pacing and/or intonation decisions, TTS/STT provider settings and/or voice selection parameters, language codes and/or speech model configurations, websocket connection and/or session data, historical conversation transcripts and/or interaction records, user profile information for personalization, knowledge base data used for contextual responses, latency measurements for different components (STT, LLM, TTS), success rates for interruption detection and/or handling, quality metrics for voice interactions and/or natural conversation flow, LLM provider configurations and/or credentials, voice AI provider integration parameters, marketplace vendor connection settings, interruption sensitivity settings, welcome greeting configurations, and/or DTMF detection and/or handling preferences, and/or any other data described herein.

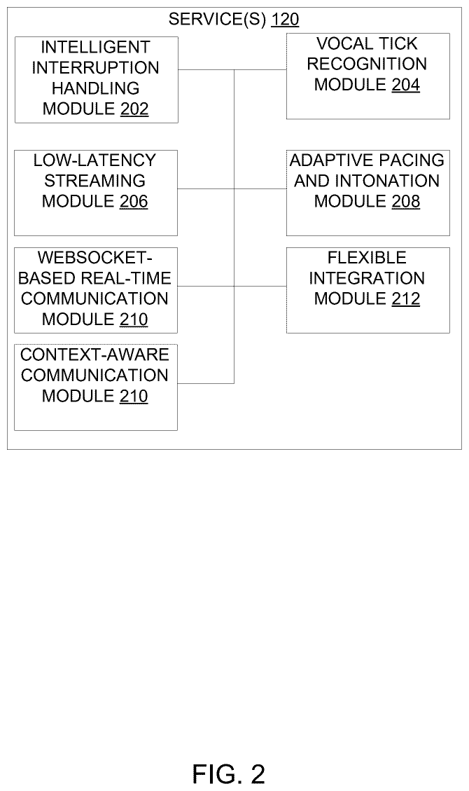

FIG. 2 is a block diagram illustrating example service(s) 120 of FIG. 1 for implementing conversational AI capabilities. The system includes multiple integrated modules that work together to enable natural voice interactions while balancing latency and personalization requirements. The modules leverage streaming capabilities, websocket connections, and/or intelligent processing to achieve responsive, context-aware conversations.

The intelligent interruption handling module 202 processes incoming audio to detect and analyze interruption patterns. Natural language processing and machine learning components evaluate speech patterns to determine when interruptions are intentional versus unintentional vocal ticks. The system maintains user profiles to track individual interaction patterns.

The vocal tick recognition module 204 analyzes audio input to distinguish between meaningful interruptions and non-interruptive sounds. Pattern recognition algorithms identify common vocal ticks like “hmm” or “uh-huh” while maintaining natural conversation flow. The system adapts to individual user patterns over time.

The low-latency streaming text tokens module 206 manages real-time processing of text tokens from language models. Intelligent buffering and chunking mechanisms analyze punctuation and semantic context to determine optimal segmentation points. The system maintains token state information while enabling immediate speech synthesis.

The adaptive pacing and intonation module 208 optimizes speaking rate and pause lengths based on conversation context. Natural language processing evaluates sentence structure and punctuation to determine appropriate pacing. The system adjusts intonation patterns while maintaining natural-sounding speech.

The websocket-based real-time communication module 210 enables bidirectional streaming of voice and text data. Connection management components handle session state and recovery procedures. The system maintains persistent connections while optimizing for minimal latency.

The flexible integration module 212 enables dynamic selection of language models and voice AI providers. Provider-specific adapters normalize interfaces across different services. The system tracks performance metrics while maintaining consistent service levels.

The context-aware conversation management module 214 tracks conversation state and history. Knowledge retrieval components integrate historical context with current interactions. The system maintains coherent dialogue while adapting to different conversation contexts.

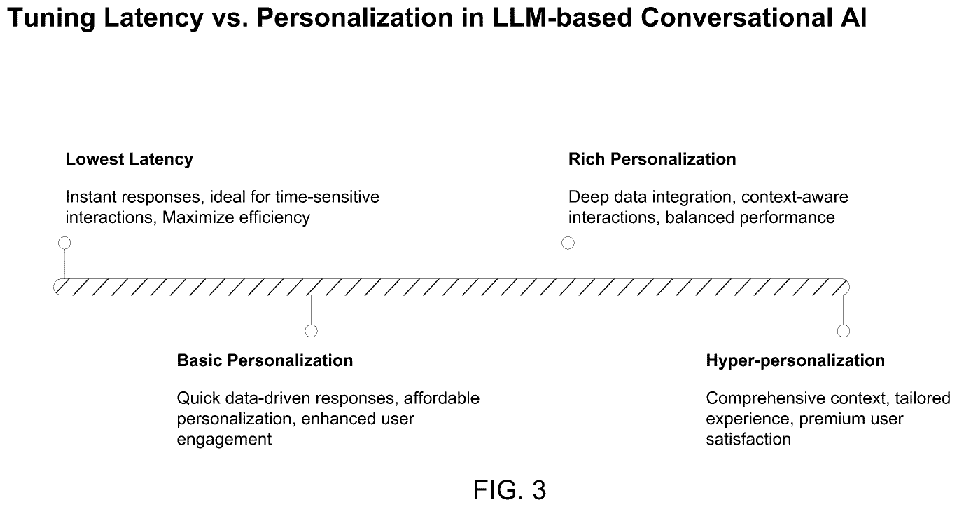

FIG. 3 is a visualization diagram illustrating a spectrum of latency versus personalization trade-offs in LLM-based conversational AI systems, represented as a gradient scale with four key points.

At the leftmost point is “Lowest Latency,” which prioritizes instant responses and maximum efficiency, ideal for time-sensitive interactions that require immediate system feedback. Moving right along the spectrum, “Basic Personalization” represents a balance point offering quick data-driven responses with affordable personalization features that enhance user engagement while maintaining relatively low latency.

Further right on the spectrum is “Rich personalization,” which provides deep data integration and context-aware interactions with balanced performance. This level incorporates more sophisticated personalization features while managing the increased latency from additional data processing and context analysis

[symbol]

At the rightmost point is “Hyper-personalization,” representing the most comprehensive context integration and tailored experiences, delivering premium user satisfaction but with higher latency due to the extensive processing required for deep personalization.

The gradient visualization demonstrates how increasing levels of personalization correspond to greater processing requirements and thus higher latency, requiring customers to make strategic decisions about the optimal balance for their specific use cases.

This trade-off may be particularly relevant for voice-based AI systems, where maintaining natural conversation flow must be balanced against the desire for more personalized interactions. The spectrum helps customers understand and configure their AI assistants based on their specific needs, whether prioritizing rapid response times for simple interactions or accepting higher latency to enable more sophisticated personalization features.

In example embodiments, the visualization of FIG. 3 demonstrates how one or more features can be configured along a spectrum from lowest latency to highest personalization. In example embodiments, for intelligent interruption handling and vocal tick recognition, the system can be tuned toward the “Lowest Latency” end to provide immediate response to interruptions, or toward “Rich personalization” to enable more sophisticated analysis of user-specific vocal patterns and contextual understanding. In example embodiments, the low-latency streaming text tokens feature operates primarily in the “Lowest Latency” and “Basic Personalization” regions, where the system optimizes token processing and delivery for immediate response.

In example embodiments, the adaptive pacing and intonation capabilities span from “Basic Personalization” to “Hyper-personalization,” where increased processing time enables more sophisticated analysis of speech patterns and context for natural-sounding output. In example embodiments, the websocket-based real-time communication architecture supports operations across the entire spectrum but is particularly crucial for achieving the performance levels shown in the “Lowest Latency” region.

In example embodiments, flexible integration with multiple LLMs allows customers to select different providers based on their desired position along this latency-personalization spectrum. In example embodiments, context-aware conversation management features operate primarily in the “Rich personalization” and “Hyper-personalization” regions, where additional processing time enables deeper context integration and more sophisticated conversation handling.

The figure shows the performance implications of different configuration choices and illustrates how the various technological components can be tuned to achieve their specific requirements for response time versus personalization depth.

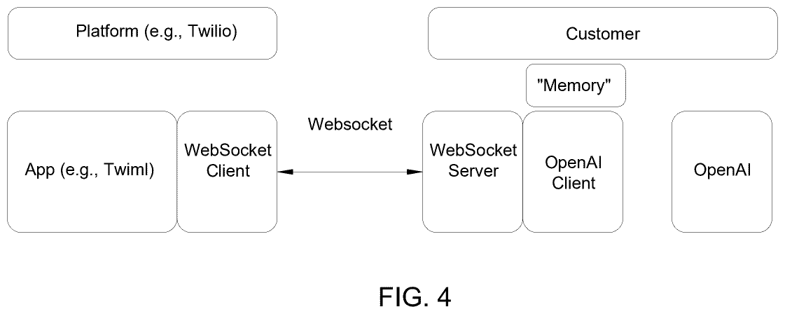

FIG. 4 illustrates an example architecture of a system configured to implement one or more of the technological solutions described herein, showing the division between platform-owned components on the left and customer-owned components on the right.

The diagram shows an application (e.g., a TwiML App) and a WebSocket client on the platform side connected via websocket to a WebSocket server on the customer side. The customer side also includes an artificial intelligence interface (e.g., an OpenAI Client) that interfaces with artificial intelligence services (e.g., OpenAI's services), and a “Memory” component for maintaining conversation context.

In example embodiments, the websocket connection between the WebSocket client and server enables real-time communication necessary for fast interruption detection and handling.

In example embodiments, the WebSocket client processes audio input and/or can analyze it for vocal ticks before sending the processed information to the server.

In example embodiments, the websocket architecture enables streaming of text tokens between components with minimal latency.

In example embodiments, the direct connection between one or more system components and artificial intelligence services allows for efficient token processing.

In example embodiments, the WebSocket client handles the processing of text tokens and manages the pacing and intonation of the speech output.

The diagram explicitly shows the websocket connection between the client and server components, which supports the system's real-time communication capabilities.

In example embodiments, the architecture allows for integration with different LLM providers through the customer-side components.

In example embodiments, the “Memory” component on the customer side enables maintaining conversation context and history

[symbol]

The diagram shows a clean separation between platform infrastructure and customer-owned components, allowing customers to maintain control over their LLM integration and/or conversation memory while leveraging the platform's voice processing capabilities.

Example platform side and customer side components are delineated in the system architecture:

In example embodiments, the platform side includes one or more of an application (e.g., a TwiML App) and a WebSocket client that handle the initial call setup and websocket connection establishment, voice processing components including Speech-to-Text (STT) and Text-to-Speech (TTS) capabilities, an API server and Web server interfaces for programmatic and web-based access, an internal adapter that integrates with an AI Assistant, platform services, including SaaS, PaaS and IaaS infrastructure, and/or database servers and storage for system data.

In example embodiments, the customer side includes one or more of a Websocket server that receives and processes communications, an artificial intelligence client (or other LLM integration) for processing natural language, a “Memory” component for maintaining conversation context, custom knowledge bases and business logic, Bot/LLM implementations specific to the customer's use case, and/or the customer's own Conversational AI Assistant implementation.

The separation allows customers to maintain control over their LLM integration and conversation memory while leveraging the platform's voice processing infrastructure.

Communication between the two sides occurs via websocket connections, with speech paths shown in a first path and text paths shown in in a second path. The customer can configure various parameters like language, voice selection, and/or interruption handling through the platform while maintaining their own business logic and AI implementations.

While FIG. 4 shows a basic client-server architecture, on-prem solutions can be implemented to enhance one or more of the technological solutions described herein.

In example embodiments, for intelligent interruption handling and/or vocal tick recognition, an on-prem processor can be deployed to handle voice-to-text conversion locally and perform preprocessing before querying the LLM, enabling faster response times for interruption detection. This local processing allows for fast analysis of audio input to distinguish between actual interruptions and vocal acknowledgments without requiring round-trips to remote servers.

In example embodiments, for low-latency streaming text tokens, on-prem processing can reduce latency by performing initial token processing and buffering locally before transmission to the LLM. The system can implement intelligent chunking and buffering algorithms directly on the customer's infrastructure to optimize streaming performance.

In example embodiments, for adaptive pacing and intonation, on-prem components can analyze punctuation and context locally to make fast decisions about speech pacing and intonation patterns. This local processing enables more sophisticated real-time control over speech output characteristics.

In example embodiments, websocket-based real-time communication can be enhanced through on-prem websocket servers that maintain persistent connections and handle session state locally. This reduces network latency and enables more efficient handling of real-time data streams.

In example embodiments, for flexible integration with multiple LLMs, on-prem solutions can act as integration hubs that manage connections to different LLM and voice AI providers while maintaining local control over provider selection and failover. The customer's infrastructure can implement custom logic for provider selection and optimization.

In example embodiments, for context-aware conversation management, on-prem solutions can maintain local conversation context and user profiles, enabling faster access to historical data and more sophisticated personalization without requiring remote lookups. The “Memory” component shown in FIG. 4 can be expanded with additional on-prem storage and processing capabilities to enhance context management.

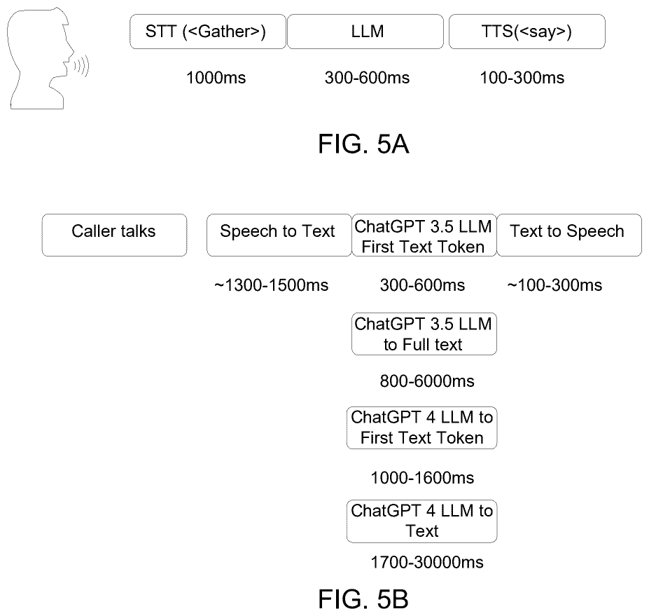

FIG. 5A illustrates example latency breakdown for different components in the voice AI system's processing pipeline. More specifically, the diagram shows three key stages with respective example latency ranges.
1. STT ( ): Speech-to-text processing may take approximately 1000 ms, representing the time needed to convert user speech input into text. This component demonstrates example baseline latency for initial processing of user speech for detecting interruptions and vocal patterns.
2. LLM: The language model processing stage may take 300-600 ms, showing the time required for the AI to process the text and generate a response. This component demonstrates example baseline latency for LLM processing and the importance of optimizing token streaming.
3. TTS ( ): The text-to-speech conversion may require 100-300 ms to generate spoken output. This component represents example baseline latency for the final stage where speech patterns and natural intonation are applied.

Thus, FIG. 5A emphasizes an example total end-to-end latency challenge that must be addressed through the various technological solutions described herein, showing why efficient bi-directional communication is crucial for maintaining natural conversation flow

[symbol]

The breakdown also illustrates example time constraints within which context processing must occur to maintain natural conversation flow.

The silhouette of a speaking person on the left side of the diagram emphasizes the human-centric nature of the system and the importance of maintaining natural conversation timing despite these processing delays.

FIG. 5B expands on the example latency breakdown shown in FIG. 5A by providing more detailed example timing information for different LLM models and processing stages.

The diagram shows the complete processing pipeline from when a caller speaks to the final text-to-speech output, with example latency ranges for each component.

The diagram shows an example initial Speech to Text processing time of ˜1300-1500 ms, which represents the window during which the system must detect and analyze interruptions and vocal patterns

[symbol]

The diagram illustrates an example difference in latency between ChatGPT 3.5 LLM's first text token (300-600 ms) and full text generation (800-6000 ms), demonstrating why streaming tokens is crucial for maintaining natural conversation flow

[symbol]

The diagram also shows even longer example latencies for ChatGPT 4 LLM, with first token taking 1000-1600 ms and full text requiring 1700-30000 ms.

The diagram shows an example text-to-speech conversion time of ˜100-300 ms, which represents the window during which the system must apply appropriate pacing and intonation to the generated speech.

The diagram illustrates why efficient websocket communication is important, as the total example end-to-end latency can range from approximately 1700 ms to over 30 seconds depending on the LLM model and processing requirements.

The diagram shows an example performance differences between ChatGPT 3.5 and ChatGPT 4 models, highlighting why flexibility in LLM selection is important for optimizing latency versus capability trade-offs.

The diagram demonstrates an example processing time required for full text generation by the LLMs (800-6000 ms for GPT-3.5, 1700-30000 ms for GPT-4), which includes the time needed for context processing and management.

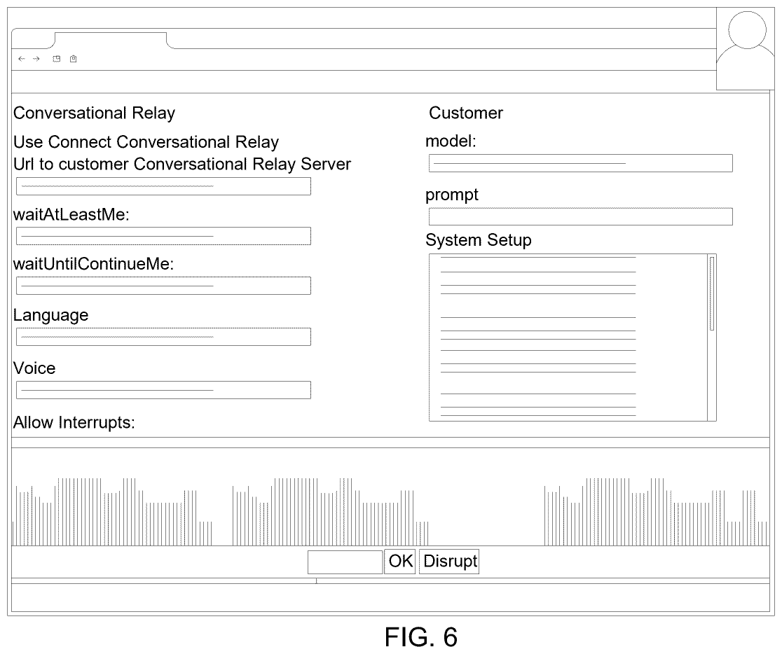

FIG. 6 shows an example user interface for configuring and testing the system. The interface is divided into two main sections—a platform (e.g., conversational relay) configuration on the left and a Customer settings configuration on the right.

The left side contains configuration options for the platform including: A URL field for specifying the customer's platform server endpoint, wait time settings in milliseconds for controlling conversation timing, language selection (set to US), voice selection (showing Google en-US-Neural2-F), and an “Allow Interrupts” toggle for enabling interruption detection

[symbol]

The right side shows the customer configuration section with model selection (showing gpt-4), a large text area for system setup and prompts, configuration for an AI assistant persona (in this case, “Jessica, the Intelligent Virtual Assistant for Zillow”).

The example user interface provides the “Allow Interrupts” toggle to enable/disable the feature, a wait time configuration options to control conversation flow. The user interface also allows selection of different language models. The user interface also provides a system prompt area for defining the AI assistant's persona and/or behavior.

The bottom of the interface shows a visualization with different waveforms, including those representing audio input/output levels and speech activity detection. This visualization helps operators monitor the real-time operation of the voice AI system.

The interface demonstrates the system's configurability and ability to tune various parameters affecting latency, personalization, and conversation management capabilities

[symbol]

It provides a unified control panel for managing both the technical aspects of voice processing and the conversational behavior of the AI assistant.

FIG. 6 demonstrates an example configuration interface that embodies several key architectural concepts of the system.
1. Separation of Platform and Customer Concerns: The interface is divided into platform settings on the left and customer configuration on the right, reflecting the fundamental architectural separation between the platform's voice processing infrastructure and customer-owned AI components.
2. Configurable Processing Pipeline: The interface exposes critical parameters that control the real-time processing pipeline, including wait times, language settings, and/or interruption handling capabilities, allowing fine-tuning of the latency-personalization trade-off.
3. AI Assistant Personality Framework: The system prompt section provides a structured way to define the AI assistant's persona, behavior guidelines, and/or conversation parameters, demonstrating the system's ability to support context-aware conversations.
4. Real-time Monitoring: The waveform visualization at the bottom represents the bidirectional nature of voice communication, showing both input and output audio streams and enabling real-time monitoring of conversation flow.
5. Integration Framework: The interface demonstrates how the system integrates various components (STT, TTS, LLM) while maintaining clear boundaries between platform capabilities and customer-specific implementations.

This interface visualization encapsulates the system's ability to balance immediate technical requirements (e.g., latency and/or voice processing) with higher-level conversational AI capabilities (e.g., personality and/or context awareness) while maintaining a clear separation between platform and customer domains.

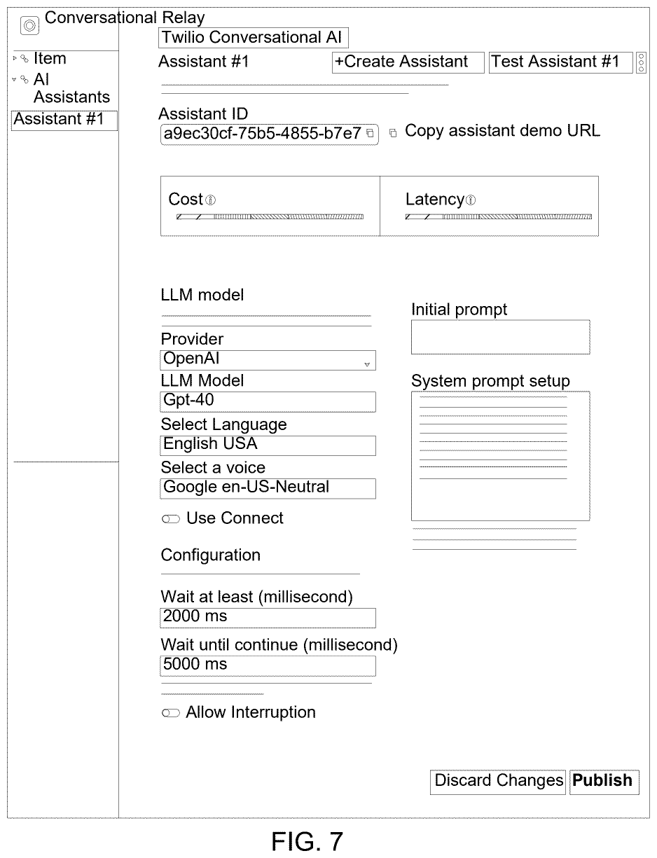

FIG. 7 illustrates a comprehensive user interface for configuring and managing AI assistants within the system.

The interface demonstrates several key capabilities.

At the top, it displays basic assistant information including an ID and description, along with visualization bars showing cost and latency metrics that help administrators understand and optimize performance trade-offs.

The LLM model section allows configuration of the AI model parameters, including: provider selection (e.g., showing OpenAI), LLM Model selection (e.g., showing GPT-4), language selection (e.g., English—USA), voice selection (e.g., Google en-US-Neural2-F)

[symbol]

The interface includes a “Use Connect Conversational Relay” toggle that enables latency optimization features, demonstrating the system's ability to balance response speed with other capabilities. The Configuration section provides granular control over the assistant's behavior: wait time settings in milliseconds to control conversation pacing, interruption handling toggles for managing real-time interactions, and/or system prompt setup for defining the AI assistant's persona and behavior guidelines.

The right side contains an initial prompt field and system prompt setup area that allows administrators to define: the assistant's opening message, personality and role definition, communication style guidelines, task instructions and conversation parameters.

This interface embodies several of the core inventive concepts, particularly: intelligent interruption handling configuration, adaptive pacing and intonation controls, flexible integration with multiple LLMs, and/or context-aware conversation management setup,

[symbol]

The interface provides a unified control panel that allows administrators to fine-tune the balance between latency and personalization while maintaining natural conversation flow. The publish/discard buttons at the bottom enable version control of configurations.

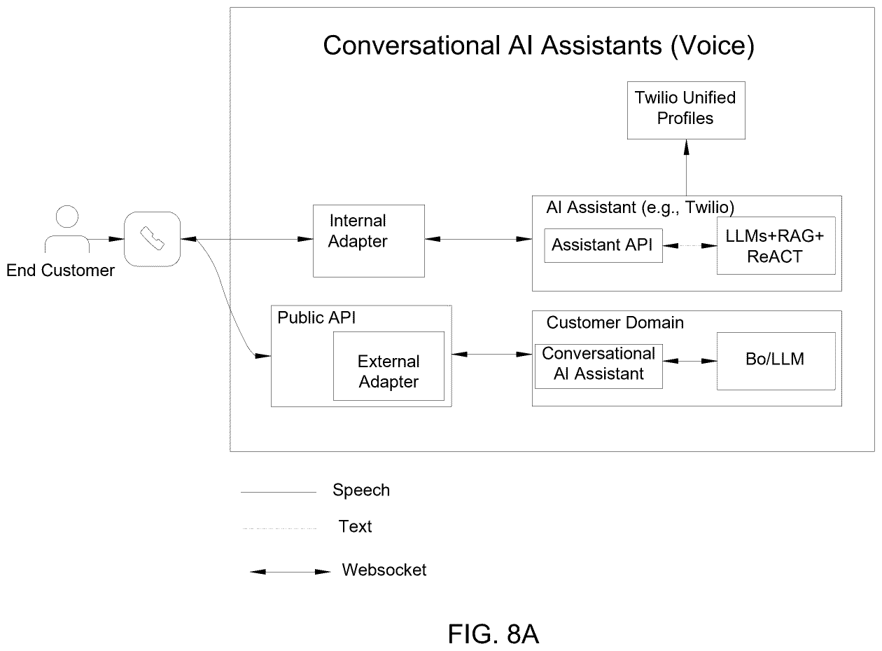

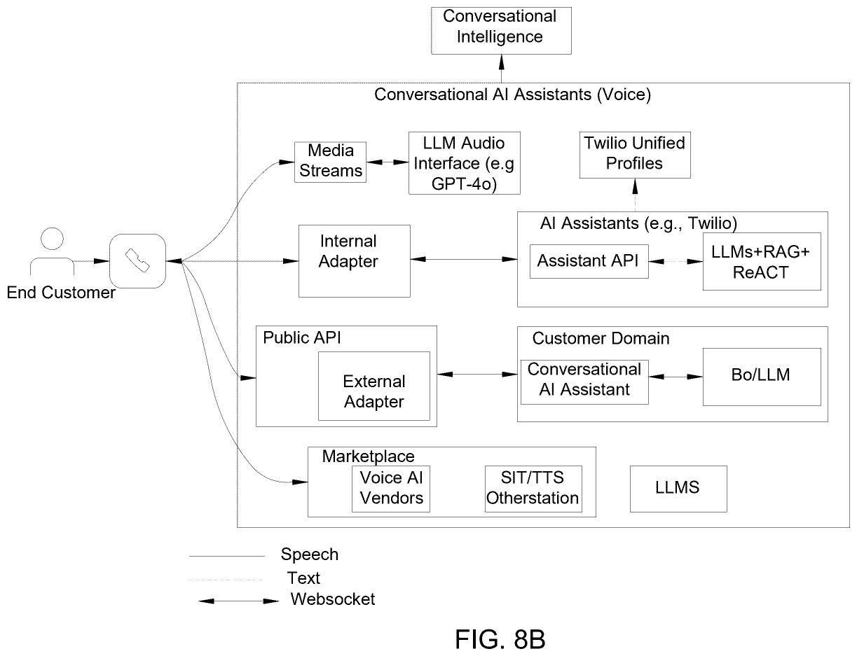

FIG. 8A illustrates an expanded architecture of the system for voice interactions, building upon the pilot implementation shown in earlier figures.

The diagram shows two key integration paths—one through an internal adapter to a platform AI Assistant, and another through an external adapter to customer domain systems.

The system introduces integration with unified profiles on the platform side, shown at the top of the diagram, which enables enhanced personalization and context awareness for conversations.

In example embodiments, the unified profiles include a system component that enables enhanced personalization and context awareness for conversations by maintaining user data and interaction history. It integrates with the AI Assistant to provide rich personalization capabilities that allow the system to access and utilize customer data for more contextual and personalized interactions.

The system can leverage unified profiles to identify specific users and their interaction patterns, enabling features like personalized vocal tick recognition and customized conversation handling based on individual user profiles. This integration allows the AI Assistant to maintain persistent user context across multiple conversations and channels, enhancing the quality of interactions through accumulated knowledge about each user's preferences and behaviors.

The architecture shows unified profiles as a bidirectional connection to the AI Assistant component, indicating it can both contribute context to ongoing conversations and be updated with new learnings from interactions. This enables the system to continuously improve its personalization capabilities by building more comprehensive user profiles over time.

The internal adapter path connects to the platform's AI Assistant API, which may include RAG (Retrieval-Augmented Generation) and ReAct capabilities for improved context understanding and response generation.

The diagram maintains separation between platform components, third-party elements, and customer-owned components.

The communication paths are represented by solid lines for speech or text, and dashed lines for websocket connections.

This architecture specifically supports several key features described herein, including intelligent interruption handling through the bidirectional websocket connections, low-latency streaming text tokens via the direct connections between components, flexible integration with multiple LLMs through both the internal and external adapter paths, context-aware conversation management (e.g., through the integration with unified profiles and RAG/ReAct capabilities).

This architecture represents an example version of the system that incorporates advanced features for personalization while maintaining core real-time communication capabilities.

FIG. 8B expands upon FIG. 8A by introducing several key additional components and integration paths, including (1) the addition of a Conversational Intelligence component at the top of the diagram, which receives and processes conversation data for analytics and insights, (2) the introduction of Media Streams integration with an LLM Audio Interface (e.g., GPT-40), shown as a new pathway for voice processing, and (3) a new Marketplace integration path that includes Voice AI vendors and STT/TTS Orchestration components, providing additional flexibility for voice processing options.

The diagram maintains the core elements from FIG. 8A, including the internal and external adapters, the connection to AI Assistant with RAG and ReAct capabilities, and the integration with unified profiles. However, it expands the architecture to show how these components interact with the new marketplace and intelligence features.

This expanded architecture demonstrates how the system can support more complex integrations while maintaining the core real-time communication capabilities established in FIG. 8A.

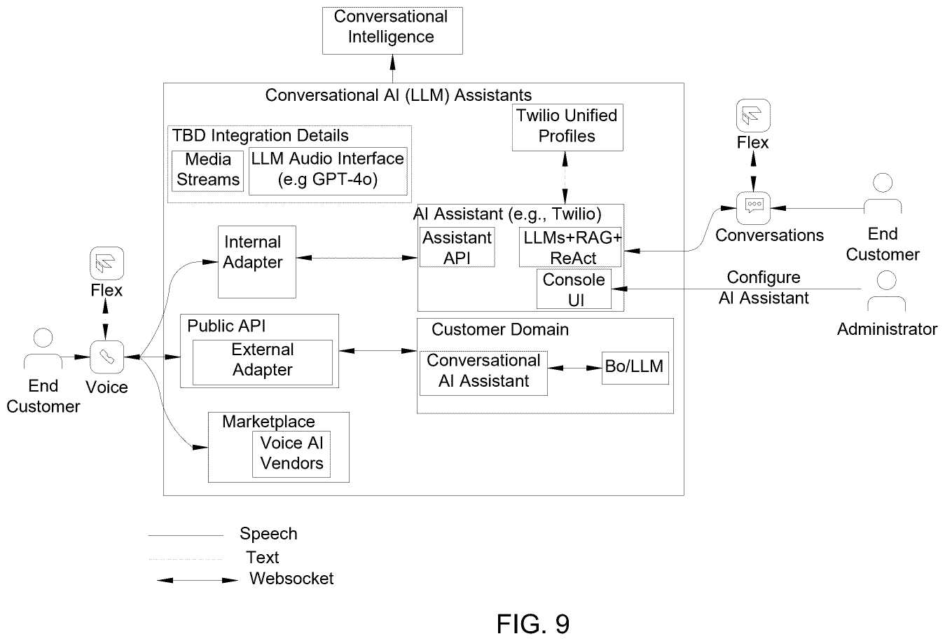

FIG. 9 expands upon the architecture shown in FIG. 8B by introducing additional integration points and user roles. The diagram shows a comprehensive end-to-end system that includes Conversational Intelligence at the top, connecting to various components through both real-time and asynchronous pathways.

The system introduces a new Administrator role who can configure and manage the AI Assistant through a Console UI, demonstrating the system's ability to be tuned and customized. The diagram also shows expanded integration with Flex, allowing for both voice and text-based conversations to be handled through the same infrastructure.

In example embodiments, Flex is a contact center solution that integrates with the Conversational AI Assistants system to enable seamless transitions between AI and human agents. It serves as both an input source for conversation transcripts and a destination for intelligent routing when human intervention is needed.

The system allows Flex to receive contextual data from AI Assistant interactions to make informed routing decisions when live agent support is required. This integration enables features like agent assistance and co-pilot capabilities while maintaining conversation context when transferring from AI to human agents.

Flex appears in the architecture diagrams as an application interface that can receive both voice and text communications. It connects to the broader Conversational Intelligence system, which processes Flex transcripts through NLU Operators to generate insights that can be used to improve both AI and human agent interactions.

The integration with Flex allows for supporting use cases where AI Assistants need to escalate conversations to human agents, ensuring that all relevant context and conversation history is preserved during the handoff. This allows for a smooth transition that maintains the quality of customer experience even when automated systems need human support.

The architecture maintains the three primary voice processing paths established in earlier figures: the internal adapter connecting to an AI Assistant, the external adapter connecting to customer domain systems, and the Marketplace integration for Voice AI vendors.

The integration with unified profiles is enhanced, showing bidirectional connections that enable rich personalization and context awareness. The AI Assistant component now explicitly shows both the Assistant API and Console UI, along with the LLMs+RAG+ReAct capabilities that provide advanced natural language understanding and generation.

This architecture demonstrates how the system supports various technological solutions described herein, such as intelligent interruption handling through the voice processing paths, low-latency streaming through the websocket connections, flexible LLM integration through multiple pathways, and/or context-aware conversation management through the unified profiles integration.

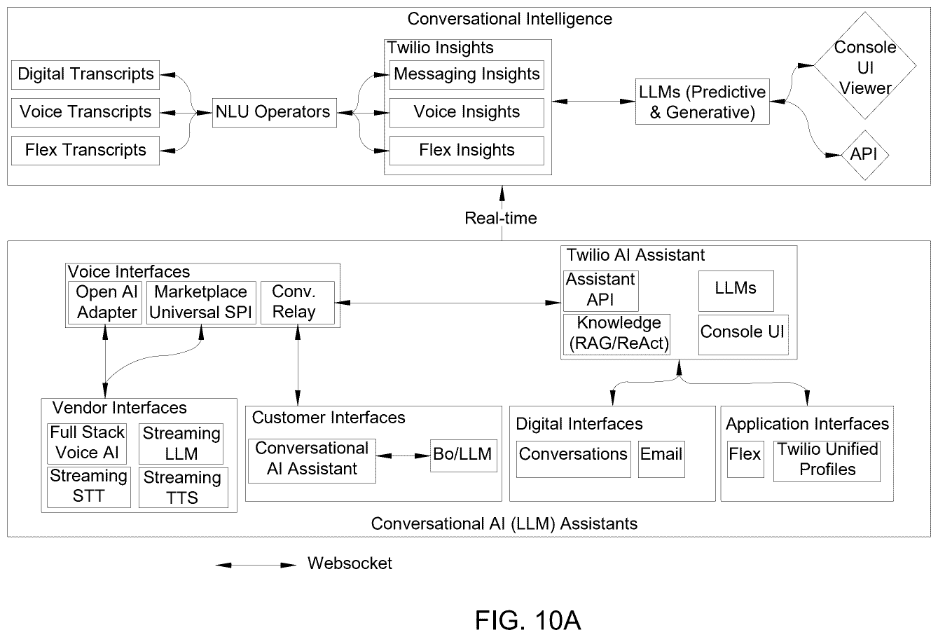

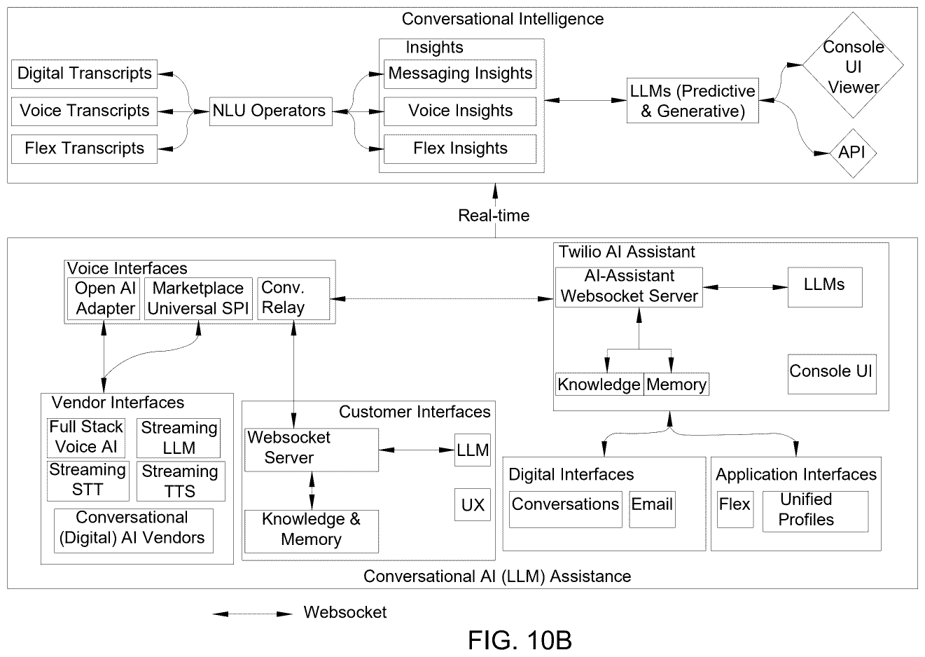

FIG. 10A illustrates an example architecture showing the integration of Conversational Intelligence with the core Conversational AI (LLM) Assistants system. The diagram is divided into two main sections: the Conversational Intelligence layer at the top and the Conversational AI (LLM) Assistants layer below.

The Conversational Intelligence section shows how different types of transcripts (e.g., Digital, Voice, and Flex) are processed through NLU Operators to generate various insights (e.g., Messaging, Voice, and Flex).

These insights are then processed by predictive and generative LLMs and made available through both a Console UI Viewer and API interface.

The lower section details the core Conversational AI system, which includes three main interface types: Voice Interfaces, Digital Interfaces, and Application Interfaces. The Voice Interfaces section includes the artificial intelligence (e.g., OpenAI) Adapter, Marketplace Universal SPI, and platform components, which handle different aspects of voice processing. These components connect to various vendor interfaces that provide capabilities like Full Stack Voice AI, Streaming LLM, Streaming STT, and Streaming TTS.

The system shows integration with the platform AI Assistant through a websocket connection, which provides access to LLMs and Knowledge (RAG/ReAct) capabilities. The Assistant API and Console UI components enable configuration and management of the AI system.

The architecture supports multiple integration paths through Customer Interfaces (e.g., showing the Conversational AI Assistant and Bot/LLM components), Digital Interfaces (e.g., including Conversations and Email), and Application Interfaces (featuring Flex and unified profiles). This design enables the system to support all key features including intelligent interruption handling, low-latency streaming, flexible LLM integration, and context-aware conversation management.

In example embodiments certain components are managed by the platform (e.g., the external adapter, internal adapter, media streams, conversational intelligence, unified profiles, assistant API, and console UI), others are managed by third parties (e.g., LLM audio interface, voice AI vendors, LLMs+RAG+React), and still others are managed by customers (e.g., conversational AI assistance, Bot/LLM).

FIG. 10B expands upon FIG. 10A by introducing several key architectural changes and additional components. The AI-Assistant Websocket Server in FIG. 10B replaces the Assistant API shown in FIG. 10A, providing a more detailed view of the server-side components. This websocket server directly connects to both Knowledge and Memory components, whereas in FIG. 10A these were shown as part of the RAG/ReAct system.

In example embodiments, some components are customer owned (e.g., conversational AI assistant, Bot/LLM, Knowledge (Rage/ReAct), others are third-party owned (e.g., LLMs (predictive and generative), LLMs used by the AI assistant, vendor interfaces), and still others (e.g., the remaining illustrated components) are owned by the platform (e.g., Twilio).

The Vendor Interfaces section in FIG. 10B adds “Conversational (Digital) AI Vendors” as a new component, expanding the system's capability to integrate with additional third-party services. This addition reflects the system's enhanced flexibility in supporting various AI service providers.

The Customer Interfaces section in FIG. 10B is more detailed, showing the Websocket Server with explicit connections to Knowledge & Memory, LLM, and UX components. This contrasts with FIG. 10A's simpler representation of the Conversational AI Assistant and Bot/LLM components.

The Digital Interfaces remain similar between the two figures, but FIG. 10B shows a more direct connection path to the AI-Assistant Websocket Server. The Application Interfaces section maintains the same components (Flex and unified profiles) but with clearer integration paths.

The Marketplace Media Adapter in FIG. 10A is replaced with a more specific “Marketplace Media Adapter” in the Voice Interfaces section of FIG. 10B, indicating a more focused approach to handling media integrations. This change better supports the system's ability to integrate with various voice AI vendors and services.

The overall architecture in FIG. 10B provides a more detailed implementation view while maintaining the same core functionality and integration capabilities shown in FIG. 10A.

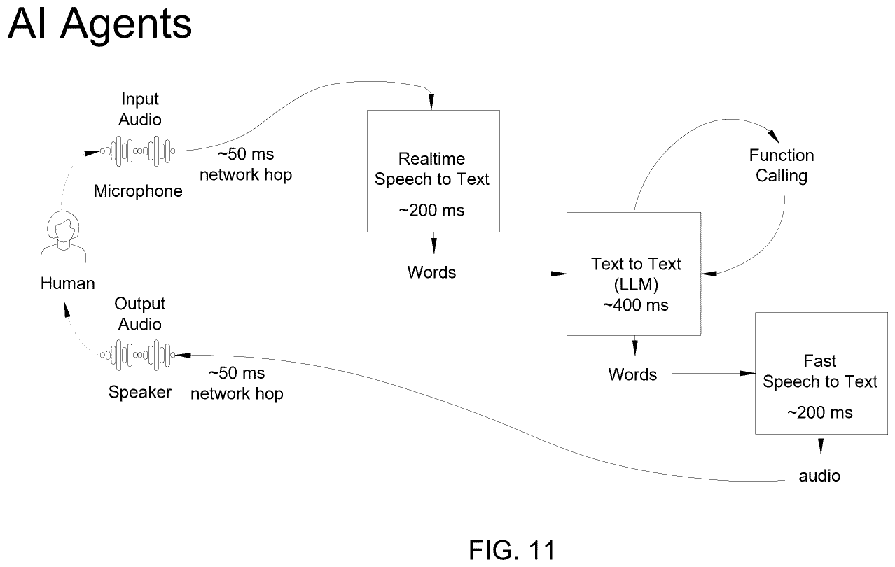

FIG. 11 illustrates an end-to-end example latency breakdown and data flow for AI Agents in the system. The diagram shows the complete path from human input to output, with example timing measurements for each component.

The flow begins with input audio from a human speaker through a microphone, which travels through a network hop taking approximately 50 ms. The audio then enters the Realtime Speech to Text component, which processes the speech in approximately 200 ms. The processed text (“words”) is then passed to the Text to Text (LLM) component, which takes approximately 400 ms to process. This component includes a “Function Calling” capability, represented by a dotted blue circle, indicating the system's ability to invoke specific functions during text processing.

After LLM processing, the text is sent to the Fast Text to Speech component, which converts the processed text back into audio in approximately 200 ms. Finally, the output audio travels through another 50 ms network hop before reaching the human listener through the speaker.

The diagram emphasizes the system's focus on minimizing latency at each stage, with the total processing time from input to output being less than a threshold processing time (e.g., 1 second). This aligns with the system's goal of achieving human-like conversation speeds while maintaining high-quality voice processing.

The visualization uses distinguish different types of data flow-for audio transmission and for text data, showing how the signal transforms between audio and text formats throughout the processing pipeline.

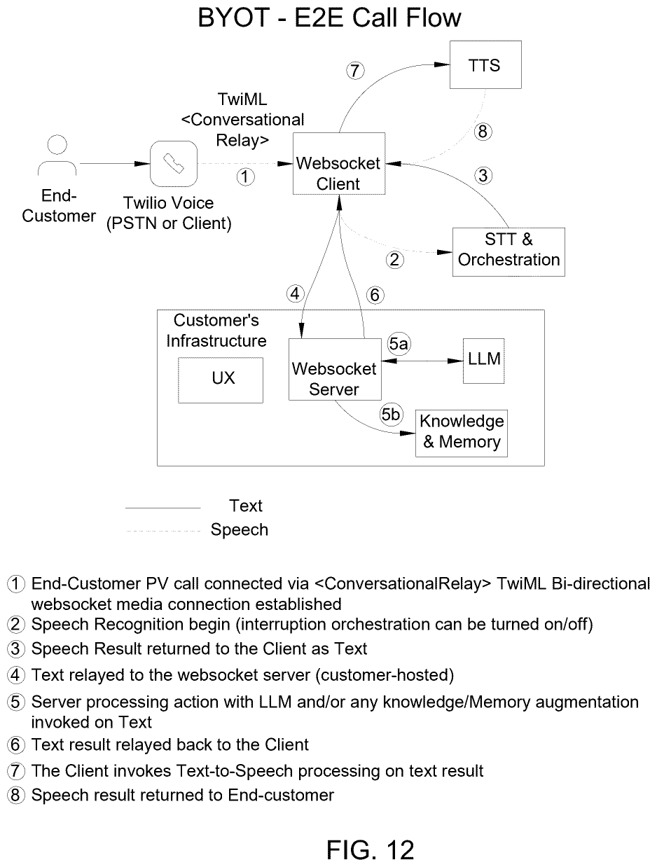

FIG. 12 illustrates an example end-to-end call flow for the system's BYOT (Bring Your Own Technology) implementation. The diagram shows an example complete interaction path between an end-customer and the system's components, with numbered steps indicating the sequence of operations.

The flow begins with an end-customer connecting through Voice (PSTN or Client) (e.g., using a TwiML command), establishing a bidirectional websocket media connection. The Websocket client then initiates speech recognition with configurable interruption orchestration capabilities.

The system processes speech through ASR & Orchestration components, which return the speech result as text to the Client. This text is then relayed to the Websocket server, which resides in the customer's infrastructure.

Within the customer's infrastructure, the Websocket server interacts with both the LLM and Knowledge & Memory components. The server processes the text through the LLM and can augment responses using the Knowledge & Memory systems.

The processed text result is then sent back to the Client, which invokes Text-to-Speech (TTS) processing. Finally, the speech result is returned to the end-customer, completing the interaction loop.

This architecture supports various features, including intelligent interruption handling, low-latency streaming, and flexible integration with customer LLM systems.

In example embodiments, the websocket client, TTS, and STT & orchestration components are owned or managed by the platform (e.g., Twilio), and the other components are owned by the customer.

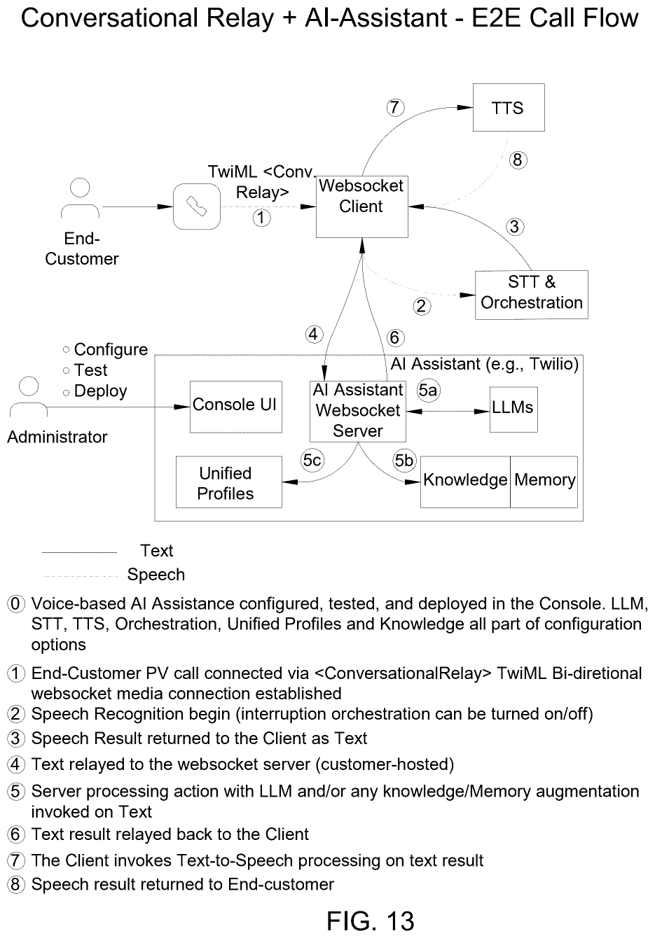

FIG. 13 expands upon FIG. 12 by introducing several key differences in the architecture and workflow for the AI Assistant integration, including the addition of an Administrator role and Console UI component in the blue box, which allows for configuration, testing, and deployment of the AI Assistant. This replaces the simpler Customer's Infrastructure box from FIG. 12.

The Websocket server from FIG. 12 is replaced with an AI Assistant Websocket server that directly interfaces with LLMs. This server also connects to both Knowledge and Memory components, with Memory being a new addition not present in FIG. 12.

The integration of Unified Profiles is shown in FIG. 13, which enables personalization and context awareness for conversations. This component was not present in the BYOT architecture of FIG. 12.

The workflow steps are similar between the two figures, but FIG. 12 adds a “step 0” that involves configuring the AI Assistant through the Console UI before any calls are processed. Additionally, step 5 in FIG. 13 specifically mentions the AI Assistant processing text through LLM(s) and invoking additional tools for Knowledge & Memory for context/personalization.

However, FIG. 13 shows more platform-owned components, reflecting a tighter integration with the platform's (e.g., Twilio's) AI Assistant platform. Both diagrams maintain the same basic flow of speech and text data and websocket connections, but FIG. 13 shows how these interactions are managed within the platform's AI Assistant infrastructure rather than customer infrastructure.

In example embodiments, LLMs may be owned or managed by third parties, knowledge may be customer owned or managed, and the remaining components may be platform (e.g., Twilio) owned or managed.

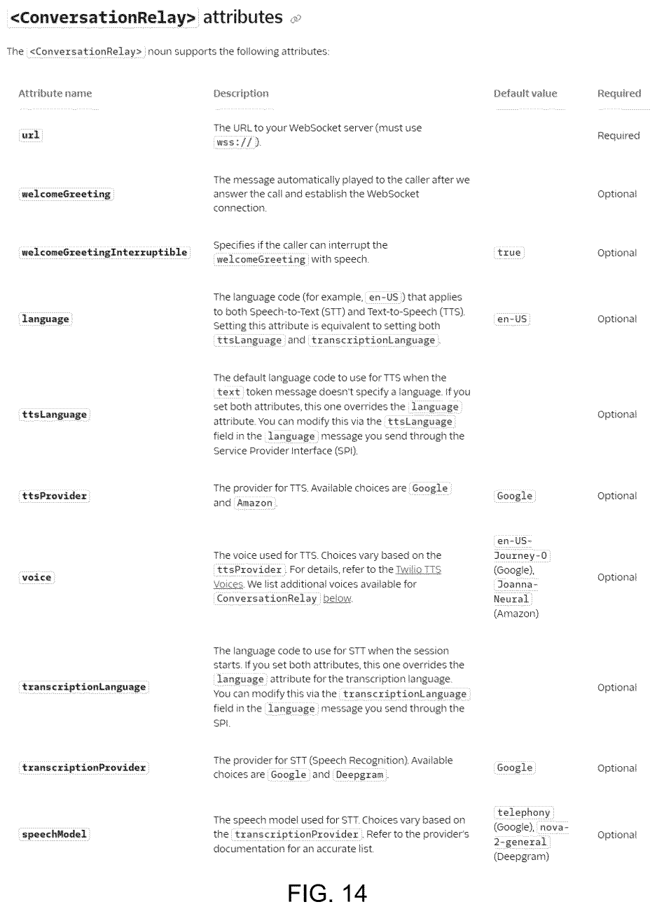

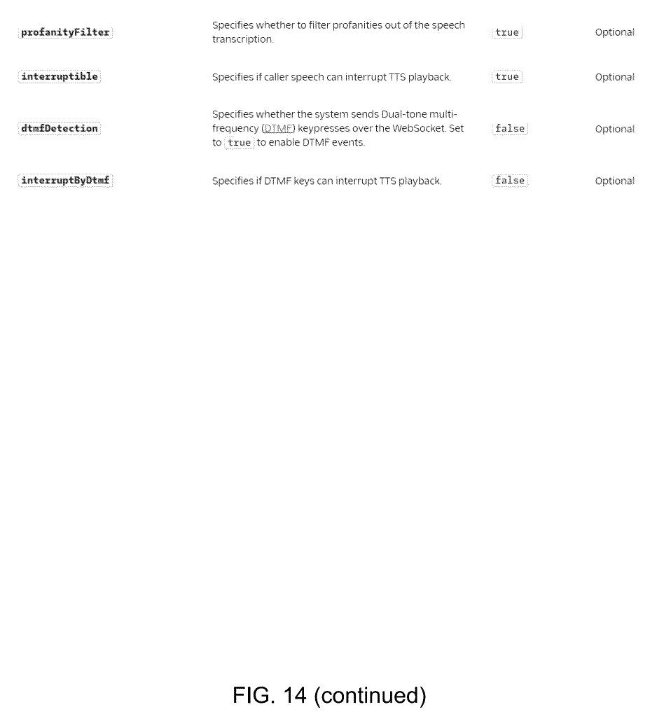

FIG. 14 shows an example table of parameters for configuring the system. The figure includes the “interruptible” parameter that “Specifies if the platform should allow the tokens being spoken to be interrupted when the caller speaks up while hearing the tokens” with a default value of “true”. This enables the core interruption detection functionality.

The “welcomeGreetingInterruptible” parameter allows configuration of whether speech interruption is allowed during the initial greeting, helping distinguish between intentional interruptions and vocal ticks.

The parameters support configuration of both speech-to-text and text-to-speech providers (“transcriptionProvider” and “ttsProvider”) to optimize for latency. The language parameter also notes it will eventually support per-token language codes from the SPI.

The “voice” parameter allows selection of different voice options through the TTS provider, enabling control over speech characteristics.

The “url” parameter specifies the required websocket server URL (must be wss://) for establishing the real-time connection.

The parameters support configuration of different providers for both speech recognition and text-to-speech (e.g., Google).

The parameters include “dtmfDetection” and “interruptByDtmf” which allow configuration of how the system handles additional input methods beyond voice, supporting more sophisticated conversation flow management.

The figure also includes additional parameters for customizing the welcome message, profanity filtering, and/or speech models, providing comprehensive configuration options for the system.

FIG. 14 is a sequence diagram illustrating an example interaction between three components: the Caller, the platform (e.g., Twilio), and the websocket server

[symbol]

The sequence begins when the Caller makes a phone call, which triggers the platform to execute a comment (e.g., a TwiML command) containing a configuration and a welcomeGreeting parameter set to “Ask me something!”.

After establishing the connection, the platform plays the welcome greeting to the Caller. The Caller responds with “Hi! How are you?”, which the platform forwards as a prompt to the websocket server.

The server processes this and responds with a series of text tokens, each marked with “last=false” until the final token. These tokens are converted to speech by the platform and delivered to the Caller as “Hi!” followed by “I am well!”.

The conversation continues with the server sending “Glad to hear. Can you count to 10?” The server then begins streaming number tokens (“One”, “Two”, “Three”, etc.) with appropriate punctuation tokens. Each token is marked as “last=false” or “last=true” to indicate whether it completes a phrase.

During the counting sequence, the Caller interrupts by saying “Let me stop you there”. The platform detects this interruption and sends an “interrupt” message to the websocket server containing two key pieces of information: “utteranceUntilInterrupt”:“Three,” and “durationUntilInterruptMs”:121. This demonstrates the system's ability to track exactly what was spoken before the interruption and how long it took.

The sequence diagram shows the granular token-by-token nature of the text streaming, with each piece of the conversation broken down into individual tokens that can be processed and interrupted in real-time. This enables the low-latency streaming and intelligent interruption handling that are core features of the system.

The diagram also illustrates how the websocket-based architecture maintains persistent connections between components, allowing for real-time bidirectional communication that supports both the streaming text tokens and immediate interrupt handling capabilities.

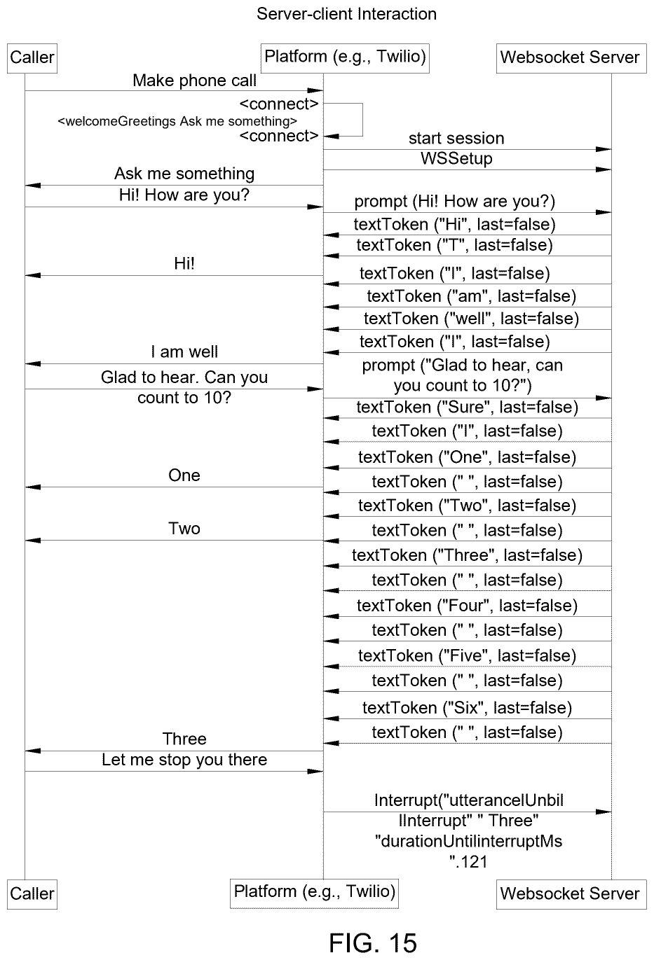

FIG. 15 is a sequence diagram showing example interactions between four main components: the platform client, customer websocket server, LLM, and TTS. The diagram demonstrates the step-by-step flow of a conversation, with particular emphasis on the token-based text streaming approach.

The sequence begins with the platform client sending initial setup information with call details to the customer websocket server. The platform client then sends a prompt “Hi! Who are you?” which the websocket server forwards to the LLM.

The LLM processes this prompt and begins streaming response tokens back through the customer websocket server. Each token is sent individually, starting with “Hello”, followed by “I am”, “an AI”, and “assistant”. The customer websocket server relays each of these text tokens back to the platform client as they are generated.

For each text token received, the platform client processes it and forwards it to the TTS component. The diagram shows this with arrows connecting to the TTS component for the complete phrase “I am an AI assistant”. This demonstrates the system's low-latency streaming capability, where text-to-speech conversion begins before the full response is complete.

The sequence concludes with a final token marked with “last=true”, indicating the completion of the response. This token-based approach, combined with the websocket protocol, enables real-time streaming and natural conversation flow while maintaining the ability to handle interruptions and manage conversation context.

The diagram effectively illustrates how the system achieves low latency by processing and converting text to speech as tokens arrive, rather than waiting for the complete response. This architecture supports both the streaming text tokens feature and the adaptive pacing capabilities of the system.

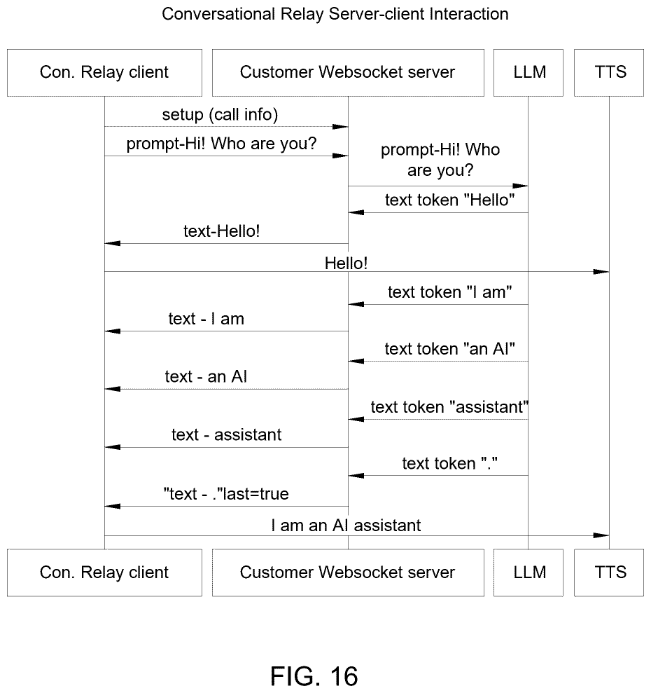

FIG. 16 is a sequence diagram showing example interactions between five components: the Caller, VTP (Voice Telephony Platform), the platform, CustomerServer, and LLM. The diagram demonstrates the complete flow of establishing a connection and handling an initial conversation.

The sequence begins with the Caller initiating a connection through a command (e.g., a TwiML command) that includes the URL parameter. The VTP forwards this to the platform, which then initiates an HTTP GET request to establish a websocket connection with the CustomerServer.

Once the socket is established, the platform sends an onOpen notification and setup call information to the CustomerServer. The CustomerServer then creates a new conversation with the LLM, which generates the initial “Ask me anything!” prompt. This prompt is broken down into individual text tokens (“Ask”, “me”, “anything”, “!”) that are sent back through the websocket connection.

The platform processes these tokens and sends “Ask me anything!” to the VTP, which delivers it to the Caller through a Say command. The VTP then initiates a Gather action to collect the Caller's response. When the Caller responds with “Ask me about Life!”, this is sent as an HTTP gather SpeechResult to the platform.

The platform forwards this prompt to the CustomerServer, which maintains a conversation history showing both “Ask me anything!” and “Ask me about Life!”. The LLM processes this and begins generating a response about life, with the first token “Life” being sent back through the websocket connection.

The diagram effectively shows how the platform manages the real-time bidirectional communication between components while handling both the text-to-speech and speech-to-text conversions through the websocket protocol. This architecture supports the system's low-latency streaming capabilities and intelligent conversation management.

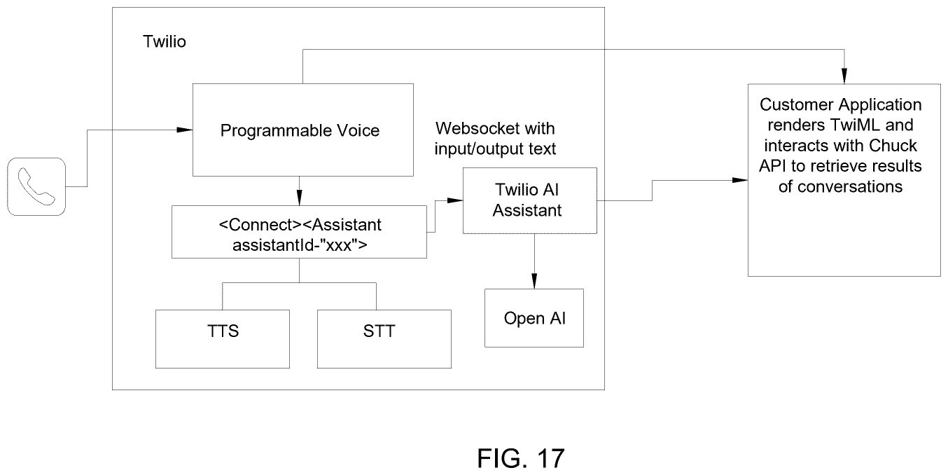

FIG. 17 is a block diagram depicting an example AI Assistant integration architecture, showing how the platform's components interact with customer applications and third-party services. The diagram begins with a phone icon connecting to the platform's Programmable Voice component. Within the platform's environment, there is a command (e.g., TwiML) element with an assistantId parameter that interfaces with the platform's AI Assistant component.

The platform integrates with two key speech processing services shown at the bottom of the platform box: ElevenLabs/Google for Text-to-Speech (TTS) and Google/Deepgram for speech recognition. These services connect to the element to handle voice processing.

The platform's AI Assistant component maintains a websocket connection with input/output text capabilities, shown by the arrow labeled “Websocket with input/output text”. This websocket connects to an artificial intelligence system (e.g., OpenAI) for language model processing.

On the right side of the diagram, a Customer Application “renders TwiML and interacts with APIs to retrieve results of conversations”. This shows how customer applications can integrate with the platform's AI Assistant capabilities through standard APIs.

The architecture demonstrates how the platform orchestrates the flow of voice and text data between various components, from initial voice input through speech recognition, AI processing, and back to speech output. This integration pattern supports the system's ability to handle real-time conversations while maintaining low latency and natural interaction patterns.

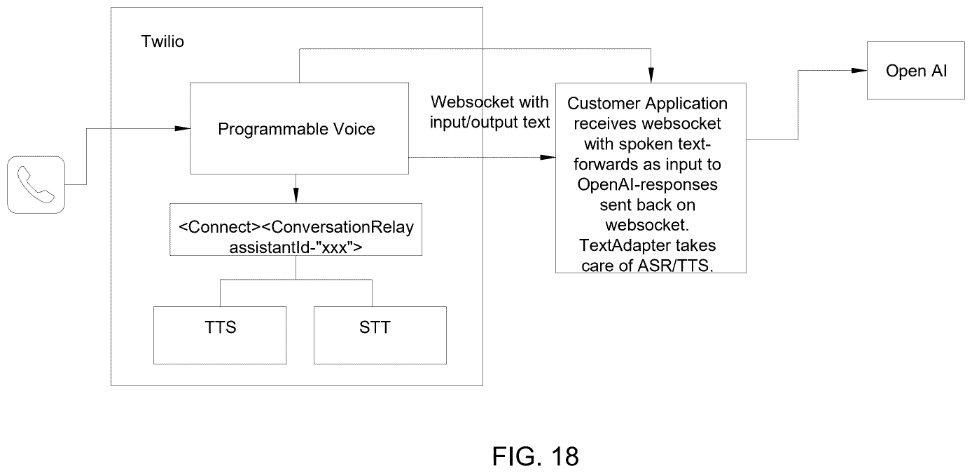

FIG. 18 is a block diagram illustrating a modified example architecture in comparison to FIG. 17, with key differences in how the platform interfaces with customer applications and handles AI processing. While both figures share the same basic components of Programmable Voice and speech processing services (e.g., ElevenLabs/Google for TTS and Google/Deepgram), FIG. 18 replaces the AI Assistant integration with a platform implementation.

For example, FIG. 18 uses a <VoxRay wss://customerserver> element instead of the element shown in FIG. 17. This change reflects a more direct integration where the customer application takes on greater responsibility for managing the AI interaction.

In FIG. 18, the Customer Application receives the websocket with spoken text and handles forwarding it as input to artificial intelligence services (e.g., OpenAI) directly, rather than relying on the platform's AI Assistant component. The customer application is also responsible for managing the responses sent back on the websocket, with the TextAdapter component handling the ASR/TTS functionality.

Another key difference is that artificial intelligence integration is handled directly by the customer application in FIG. 18, whereas in FIG. 17 it was managed through the platform's AI Assistant. This gives customers more direct control over the AI interaction but requires them to implement their own text adaptation and conversation management logic.

The websocket connection in FIG. 18 carries input/output text directly between the platform and customer application, creating a more streamlined but less managed communication path compared to the AI Assistant-mediated approach shown in FIG. 17.

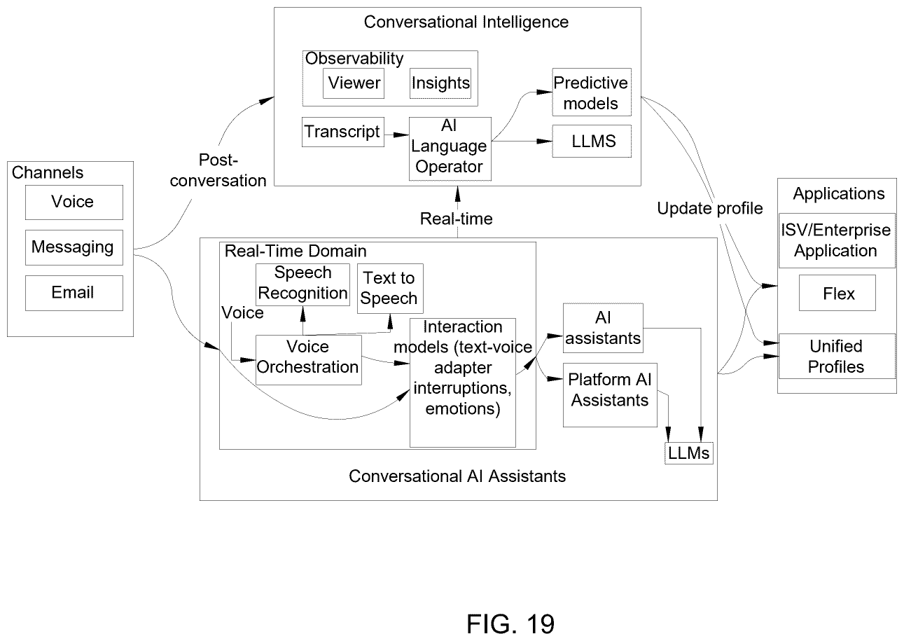

FIG. 19 illustrates a comprehensive system architecture diagram showing the integration of multiple components for Conversational AI Assistants. The diagram is organized into several key sections, each outlined in red boxes: Channels, Conversational Intelligence, Real-Time Domain, and Applications.

The Channels section on the left shows three input methods: Voice, Messaging, and E-mail, with Messaging and E-mail highlighted in pink to indicate future state components. These channels feed into both post-conversation processing and real-time processing paths.

The Real-Time Domain section, highlighted by a yellow border, contains the core processing components. It includes Speech Recognition and Text to Speech modules shown in blue (indicating third-party components), connected to Voice Orchestration shown in pink (indicating future state). The Voice Orchestration component connects to an Interaction models module that handles text-voice adapter, interruptions, and emotions.

The system includes AI assistants, specifically the platform AI Assistants (Alpha) component, which interfaces with LLMs. This integration enables real-time processing of conversations while maintaining context and supporting natural interaction patterns.

The Conversational Intelligence section at the top shows the post-conversation processing capabilities, including Observability (with Viewer and Insights components), Transcripts, and AI Language Operators. These feed into Predictive models and LLMs for advanced analysis.

The Applications section on the right shows ISV/Enterprise Applications, Flex, and Unified Profiles, demonstrating how the system integrates with various business applications. The diagram includes a Legend at the bottom that distinguishes between Current, Future State, Current State, and 3rd Party components using different visual indicators.

The entire system is interconnected with arrows showing data flow between components, with particular emphasis on the real-time processing path through the Voice Orchestration and AI assistants components. This architecture supports key features including intelligent interruption handling, low-latency streaming, and context-aware conversation management.

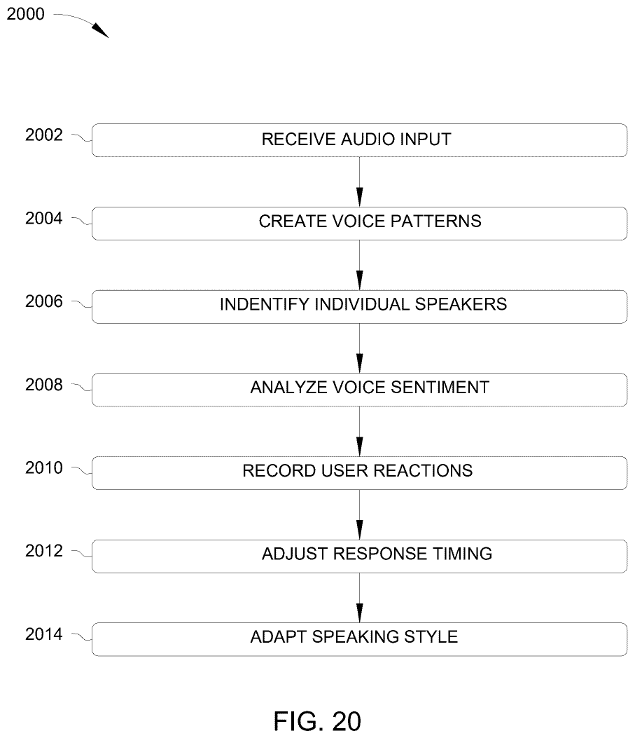

FIG. 20 illustrates example operations for implementing intelligent interruption handling. The operations may, for example, process incoming audio, detect and analyze speech patterns, manage token streams, and/or control text-to-speech output. The operations may work together to enable sophisticated features like user-specific vocal tick recognition, sentiment-based interruption analysis, and/or adaptive learning from conversation outcomes. The system leverages speech recognition services with low latency and implements real-time token streaming for natural conversation flow, while maintaining user profiles to track and learn from individual interaction patterns. The system architecture supports both anonymous session-based learning and persistent user profiles for identified callers, enabling increasingly personalized and accurate interruption handling over time.

At operation 2002, incoming audio is received and initial signal processing is performed. User profile information may be accessed (e.g., from unified profiles for identified users) or anonymous session profiles may be created to track user characteristics during the conversation and/or enable personalized interaction tracking.

At operation 2004, individual voice pattern profiles may be created and/or maintained for identified and/or anonymous users; speaking habits, common vocal ticks, and interaction patterns specific to each user may be tracked; and/or profiles may be updated in real-time as new patterns are detected.

At operation 2006, individual speakers in multi-party conversations may be identified, transcribed text may be tagged with speaker identity information, and/or recognized speech patterns may be associated with specific user profiles.

At operation 2008, sentiment may be analyzed through voice characteristics like volume, tone, and speaking rate, emotional indicators may be used to adjust interruption sensitivity, user reactions may be learned from to improve interruption detection accuracy, separate interruption thresholds may be maintained for different users based on their profiles.

At operation 2010, user reactions to interruption decisions may be recorded, user profiles may be updated with successful/unsuccessful interruption determinations, positive/negative reinforcement may be used to refine interruption detection, and/or token processing may be adapted based on learned user preferences.

At operation 2012, response timing may be adjusted based on learned user preferences, sentiment analysis may be used to modify interruption handling, user profiles may be updated with conversation history and outcomes, feedback may be provided to the learning system about interruption decisions.

At operation 2014, speaking rate and style may be adjusted based on user profiles, intonation patterns may be modified to match learned user preferences, pause lengths may be adjusted according to individual user interaction patterns, and timing parameters may be updated based on successful/unsuccessful interactions.

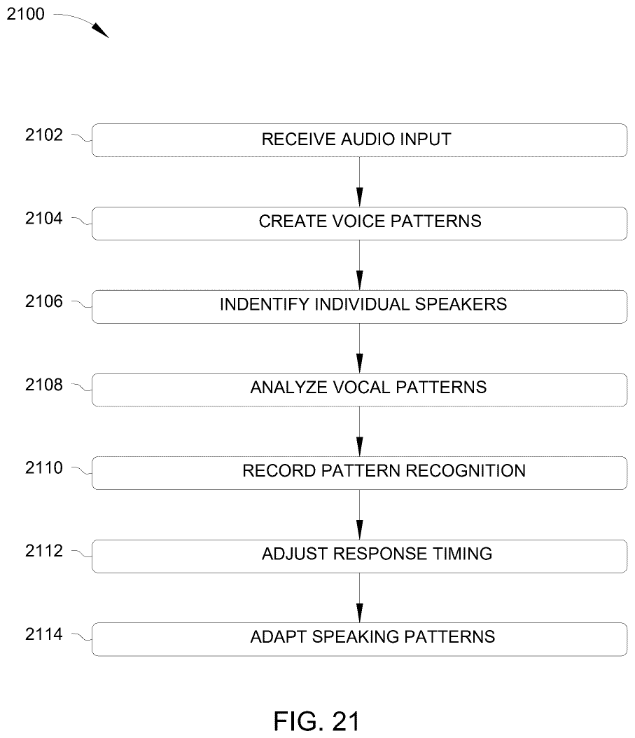

FIG. 21 illustrates example operations for implementing vocal tick recognition in voice communications. The operations enable sophisticated analysis and processing of non-interruptive vocal expressions while maintaining user profiles to learn and adapt to individual speaking patterns over time. The system leverages natural language processing and machine learning to distinguish between actual interruptions and common vocal acknowledgments, while building both anonymous session-based and persistent user profiles to enable increasingly accurate recognition.

At operation 2102, incoming audio is received and initial signal processing is performed. User profile information may be accessed from unified profiles for identified users, or anonymous session profiles may be created to track speaking patterns during the conversation. The system begins monitoring for potential vocal expressions while maintaining context about the ongoing dialogue.

At operation 2104, voice pattern profiles are created and maintained for both identified and anonymous users. Speaking habits and common vocal expressions specific to each user are tracked and analyzed. The system continuously updates these profiles in real-time as new patterns are detected and classified.

At operation 2106, individual speakers in multi-party conversations are identified and their speech patterns are analyzed. The system associates recognized vocal patterns with specific user profiles and maintains a database of known expressions and their typical meanings in conversation.

At operation 2108, sentiment analysis is performed through voice characteristics including volume, tone, and speaking rate. The system uses these emotional indicators to distinguish between affirmative sounds and actual interruption attempts. User reactions are monitored to improve pattern recognition accuracy.

At operation 2110, user reactions to pattern recognition decisions are recorded and profiles are updated with successful and unsuccessful determinations. The system employs positive and negative reinforcement to refine its recognition capabilities and adapts processing parameters based on learned user preferences.

At operation 2112, response timing is adjusted based on recognized vocal patterns and learned user preferences. The system maintains conversation flow for non-interruptive sounds while providing appropriate acknowledgment of affirmative expressions. The conversation history and outcomes are used to update user profiles.

At operation 2114, speaking rate and interaction patterns are adapted based on user profiles and historical success metrics. The system continuously refines its vocal pattern recognition capabilities through machine learning and feedback mechanisms, while optimizing response timing for different types of expressions.

FIGS. 20 and 21 show two different implementations of the voice processing system. Both implementations may use the same core components (e.g., ElevenLabs/Google TTS and/or Google/Deepgram) for speech processing, which would be used to execute the operations described in both FIG. 20 and FIG. 21. FIG. 19 provides a broader architectural view showing how these components fit into the overall Conversational AI Assistant framework, including the interaction models that handle interruptions and emotions, which directly relate to the operations described in both FIG. 20 and FIG. 21. FIG. 20 focuses on interruption handling operations while FIG. 21 focuses on vocal tick recognition operations, but both sets of operations would be implemented using the same underlying architecture and components shown in these figures.

In example embodiments, the operations in FIG. 20 and FIG. 21 work together (e.g., through the interaction models shown in FIG. 19's “Real-Time Domain” section). In example embodiments, when incoming audio is received (e.g., operation 2002 of FIGS. 20 and 2102 of FIG. 21), the Voice Orchestration component processes it through both the interruption handling logic of FIG. 20 and the vocal tick recognition logic of FIG. 21. The sentiment analysis performed in operation 2008 of FIG. 20 works in conjunction with the vocal pattern analysis of operation 2108 in FIG. 21 to make more accurate determinations about user intent.

In example embodiments, the learning and profile management aspects are also tightly integrated. For example, as user reactions are recorded (operation 2010 of FIG. 20), this information is used to update the vocal tick profiles (operation 2110 of FIG. 21)

[symbol]

Similarly, the response timing adjustments made in operation 2012 of FIG. 20 may be informed by the vocal pattern recognition in operation 2112 of FIG. 21. This integration enables the system to provide increasingly personalized and natural conversation experiences by combining interruption handling with sophisticated vocal pattern recognition.

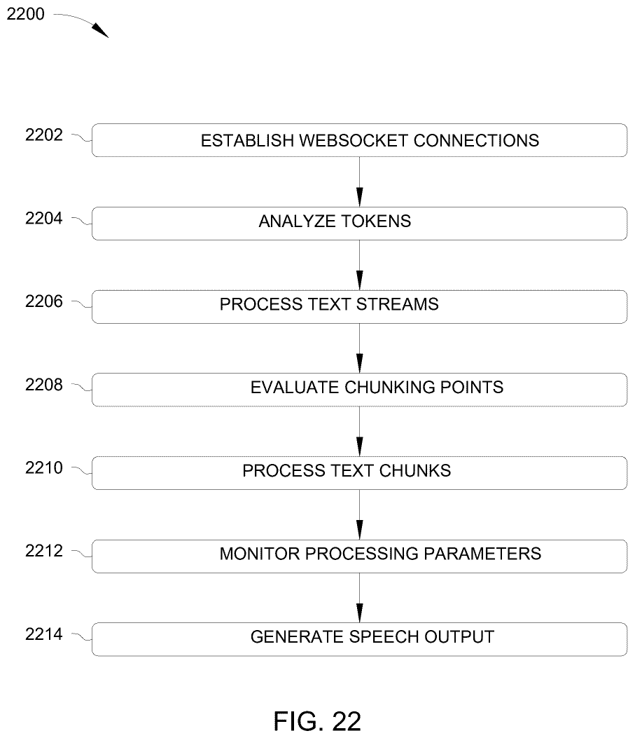

FIG. 22 illustrates example operations for implementing low-latency streaming text tokens in voice communications. The operations enable real-time processing of text tokens from language models while maintaining natural conversation flow through intelligent buffering and chunking mechanisms. The system leverages streaming speech recognition and text-to-speech services with bidirectional websocket connections to achieve minimal latency for round-trip voice interactions.

At operation 2202, incoming audio is received and initial signal processing is performed. Websocket connections are established for bidirectional real-time communication between components, enabling streaming of audio and text data with minimal delay.

At operation 2204, text tokens are analyzed to determine optimal chunking points. Natural language processing is employed to identify appropriate segmentation boundaries based on punctuation, sentence structure, and semantic meaning. A buffer of tokens is maintained while potential break points are continuously evaluated.

At operation 2206, text streams are processed by examining periods, commas, and other punctuation marks. Common abbreviations such as “Dr.” or “Mr.” are identified and handled specially to prevent inappropriate breaks. Heuristics are employed to determine when chunks are sufficiently complete for natural speech synthesis.

At operation 2208, potential chunking points are evaluated by examining surrounding context. Multiple words surrounding punctuation marks are analyzed to ensure natural speech flow. Special handling is implemented for cases such as names following commas to prevent unnatural breaks in speech output.

At operation 2210, text chunks are processed through the text-to-speech engine as soon as they are determined to be complete. Speech output begins while additional tokens are still being generated. State information is maintained to track processed content.

At operation 2212, processing parameters are continuously monitored and adjusted. Response timing is balanced against natural speech pattern requirements. Successful chunk boundaries are tracked and used to refine future chunking decisions.

At operation 2214, text-to-speech output is generated and delivered. Streaming capabilities are leveraged where available, with optimized chunking used for providers without native streaming support. Performance metrics are gathered to enable continuous improvement of the chunking and delivery mechanisms.

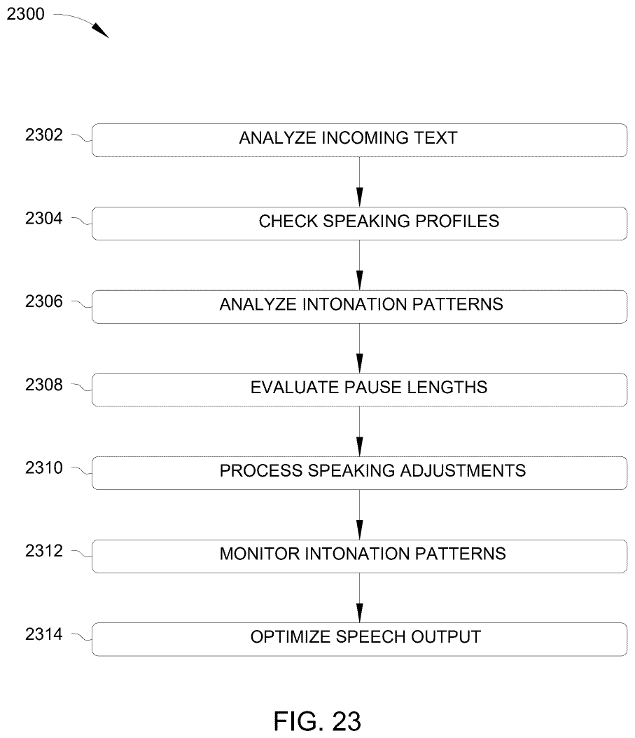

FIG. 23 illustrates example operations for implementing adaptive pacing and intonation in voice communications. The operations enable natural-sounding speech output through intelligent analysis of punctuation, context, and user interaction patterns. The system leverages natural language processing and machine learning to optimize speaking rate, pause lengths, and intonation patterns while maintaining conversation flow.

At operation 2302, incoming text is received and initial linguistic analysis is performed. Punctuation marks, sentence structure, and semantic context are analyzed to determine appropriate pacing and intonation patterns.

At operation 2304, speaking rate profiles are created and maintained for different conversation contexts. Natural pausing points are identified based on punctuation and semantic analysis, while common abbreviations and special cases are handled appropriately.

At operation 2306, intonation patterns are analyzed and optimized for natural speech flow. Multiple words surrounding punctuation marks are examined to prevent unnatural breaks, with special handling implemented for cases like names following commas.

At operation 2308, pause lengths are evaluated and adjusted based on conversation context. The system analyzes sentence structure and semantic meaning to determine appropriate pause durations, while maintaining natural conversation rhythm.

At operation 2310, speaking rate adjustments are processed through the text-to-speech engine. Parameters are tuned based on punctuation patterns and semantic context, while maintaining natural-sounding output that mimics human speech patterns.

At operation 2312, intonation patterns are continuously monitored and refined. The system tracks successful speech patterns and uses this information to improve future pacing and intonation decisions, while maintaining consistent and natural-sounding output.

At operation 2314, overall speech output is optimized for natural conversation flow. The system balances speaking rate, pause lengths, and intonation patterns while adapting to different conversation contexts and user preferences.

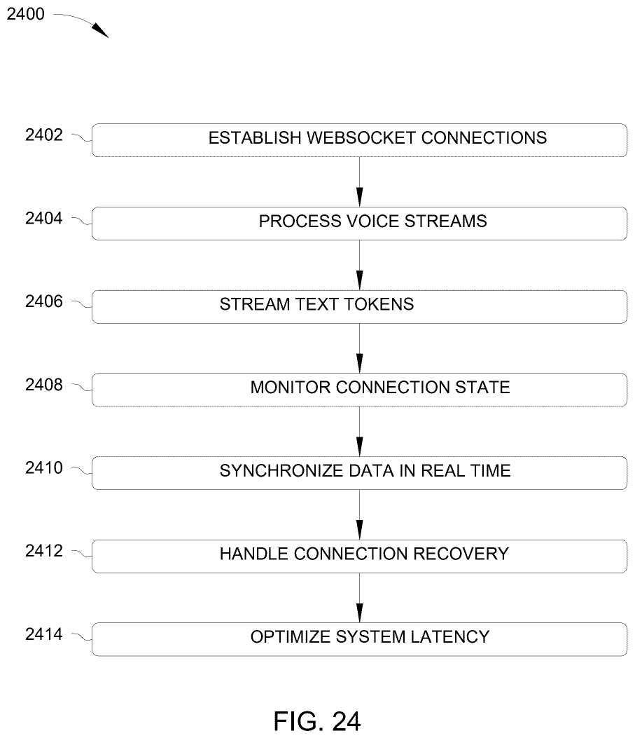

FIG. 24 illustrates example operations for implementing websocket-based real-time communication in voice interactions. The operations enable bidirectional, low-latency communication between system components while maintaining persistent connections for streaming voice and text data. The system leverages websocket protocols to achieve minimal latency for real-time voice interactions while handling connection state and session management.

At operation 2402, websocket connections are established and initial handshaking is performed. Connection parameters are configured for bidirectional communication, and session state information is initialized for tracking the ongoing interaction.

At operation 2404, voice data streams are processed through the established websocket channels. Audio input is captured and transmitted with minimal buffering, while maintaining connection state and handling any network-related interruptions.

At operation 2406, text tokens are streamed between system components through the websocket connections. The bidirectional nature of the websockets enables simultaneous transmission of speech-to-text results and text-to-speech commands while maintaining conversation state.

At operation 2408, connection state is monitored and managed across system components. Session information is maintained throughout the conversation, while network conditions are continuously evaluated to ensure optimal performance.

At operation 2410, real-time data synchronization is performed between components. The websocket protocol enables fast propagation of state changes and conversation updates across the system while maintaining consistency.

At operation 2412, connection recovery and error handling procedures are executed as needed. The system monitors connection health and implements automatic reconnection strategies while preserving conversation state during temporary disruptions.

At operation 2414, overall system latency is optimized through efficient websocket utilization. Connection parameters are tuned based on network conditions and usage patterns while maintaining reliable real-time communication between all system components.

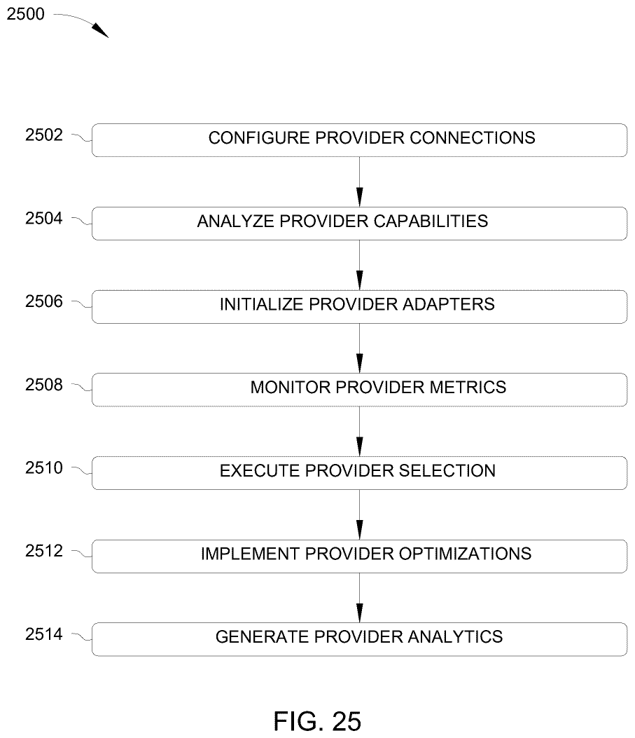

FIG. 25 illustrates example operations for implementing flexible integration with multiple language models and voice AI providers in communications systems. The operations enable dynamic selection and configuration of different providers for speech recognition, text-to-speech, and language model services while maintaining consistent interfaces and performance metrics. The system leverages a marketplace model to allow customers to choose and switch between different service providers based on their specific requirements.

At operation 2502, provider configuration information is received and service connections are established. Integration parameters are configured for each selected provider, while maintaining unified interfaces for speech-to-text, text-to-speech, and language model services.

At operation 2504, provider capabilities are analyzed and service levels are determined. Performance characteristics and feature support are evaluated for each provider, while maintaining compatibility with the platform's requirements for real-time communication.

At operation 2506, provider-specific adapters are initialized and configured. Integration layers are established to normalize provider interfaces, while maintaining consistent data formats and communication protocols across different services.

At operation 2508, provider performance metrics are monitored and analyzed. Service quality indicators are tracked across providers, while maintaining records of latency, accuracy, and reliability measurements.

At operation 2510, dynamic provider selection and failover procedures are executed. Service routing decisions are made based on performance metrics and customer preferences, while maintaining system reliability through automated provider switching.

At operation 2512, provider-specific optimizations are implemented and tuned. Integration parameters are adjusted based on observed performance, while maintaining optimal service levels across different providers.

At operation 2514, cross-provider analytics and reporting are generated. Performance comparisons and usage statistics are compiled across providers, while maintaining comprehensive monitoring of system-wide service quality.

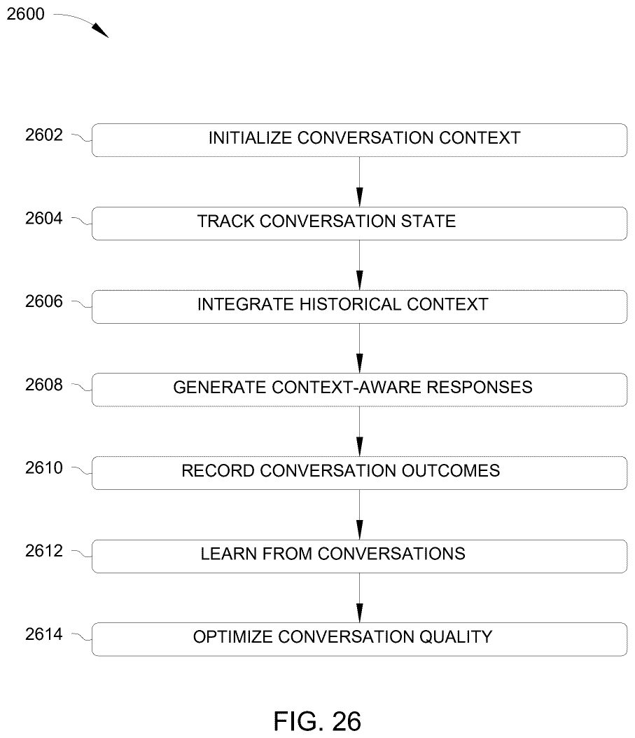

FIG. 26 illustrates example operations for implementing context-aware conversation management in voice communications. The operations enable sophisticated tracking and utilization of conversation context while maintaining conversation history and state across multiple interactions. The system leverages natural language processing and machine learning to understand conversation flow, manage context, and provide appropriate responses based on historical interactions.

At operation 2602, conversation context is initialized and historical data is accessed. Previous conversation records are retrieved for identified users, while new context tracking is established for anonymous sessions. The system begins monitoring the conversation while maintaining awareness of prior interactions.

At operation 2604, conversation state and context are tracked and maintained throughout the interaction. Key discussion points, user preferences, and interaction patterns are recorded and analyzed. The system continuously updates its understanding of the conversation flow and context.

At operation 2606, historical context is integrated with current conversation state. Previous interactions are analyzed to inform current responses, while maintaining consistency across multiple conversation turns. The system associates recognized patterns with specific conversation contexts.

At operation 2608, context-aware response generation is performed through analysis of conversation history and current state. The system evaluates appropriate responses based on accumulated context while maintaining natural conversation flow.

At operation 2610, conversation outcomes and context updates are recorded and processed. The system tracks successful and unsuccessful interactions while updating its contextual understanding based on conversation results.

At operation 2612, context-based learning and adaptation are performed across conversations. The system refines its context management based on observed patterns and outcomes while maintaining consistent conversation state.

At operation 2614, overall conversation quality is optimized through context-aware processing. The system balances immediate responses with historical context while maintaining natural and coherent interactions across multiple conversation turns.

### Example Mobile Device

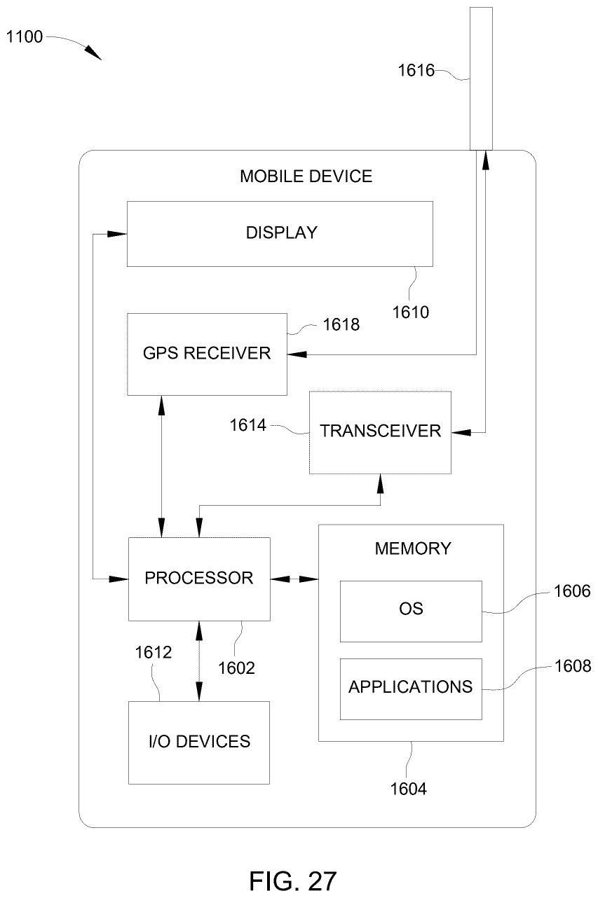

FIG. 27 is a block diagram illustrating a mobile device 1100, according to an example embodiment.

The mobile device 4300 can include a processor 1602. The processor 1602 can be any of a variety of different types of commercially available processors suitable for mobile devices 4300 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 4300. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

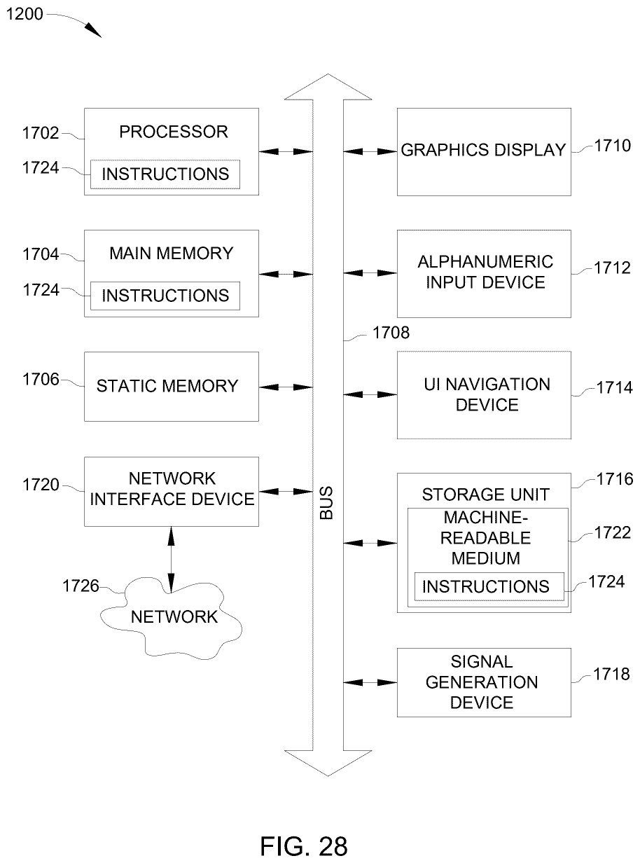

FIG. 28 is a block diagram of an example computer system 1200 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4400 includes a processor 1702 (e.g., a central processing unit (CPU), a graphics processing unit (GPU) or both), a main memory 1704 and a static memory 1706, which communicate with each other via a bus 1708. The computer system 4400 may further include a graphics display unit 1710 (e.g., a liquid crystal display (LCD) or a cathode ray tube (CRT)). The computer system 4400 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 4400, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving audio input during an artificial intelligence (AI) voice interaction between a user and an AI assistant;
analyzing the audio input in real-time to determine whether the audio input represents an intended interruption of the AI assistant's speech;
in response to determining the audio input represents an intended interruption, stopping the AI assistant's speech and tracking what portion of a response was actually spoken; and
maintaining context awareness by storing information about the interrupted response to allow resuming from the point of interruption.

2. The system of claim 1, wherein the analyzing the audio input comprises:
accessing a user profile containing historical interaction patterns for the user; and
determining whether the audio input matches known vocal patterns associated with intended interruptions for the user based on the historical interaction patterns.

3. The system of claim 1, wherein the analyzing the audio input comprises:
detecting whether the audio input represents an affirmative acknowledgment rather than an intended interruption; and
continuing the AI assistant's speech without interruption in response to detecting an affirmative acknowledgment.

4. The system of claim 1, wherein the analyzing the audio input comprises:
processing the audio input using an on-premise processor to perform initial voice-to-text conversion locally;
performing preprocessing of the converted text before communicating with a language model; and
determining interrupt intent based on the preprocessing.

5. The system of claim 1, wherein the analyzing the audio input comprises:
analyzing sentiment through voice characteristics including volume, tone, or speaking rate; and
adjusting interruption sensitivity based on the analyzed sentiment.

6. The system of claim 1, wherein the analyzing the audio input comprises:
categorizing sounds in the audio input as either meaningful interruptions or non-interruptive vocal ticks; and
continuing the AI assistant's speech without interruption in response to detecting a non-interruptive vocal tick.

7. The system of claim 6, wherein the categorizing of the sounds comprises:
updating the user profile with specific vocal patterns specific to the user over time by tracking speaking habits and common vocal expressions;
identifying whether detected sounds match known vocal tick patterns in the user profile; and
using machine learning to detect whether sounds indicate acknowledgment or interruption intent.

8. A method comprising:
receiving audio input during an artificial intelligence (AI) voice interaction between a user and an AI assistant;
analyzing the audio input in real-time to determine whether the audio input represents an intended interruption of the AI assistant's speech;
in response to determining the audio input represents an intended interruption, stopping the AI assistant's speech and tracking what portion of a response was actually spoken; and
maintaining context awareness by storing information about the interrupted response to allow resuming from the point of interruption.

9. The method of claim 8, wherein the analyzing the audio input comprises:
accessing a user profile containing historical interaction patterns for the user; and
determining whether the audio input matches known vocal patterns associated with intended interruptions for the user based on the historical interaction patterns.

10. The method of claim 8, wherein the analyzing the audio input comprises:
detecting whether the audio input represents an affirmative acknowledgment rather than an intended interruption; and
continuing the AI assistant's speech without interruption in response to detecting an affirmative acknowledgment.

11. The method of claim 8, wherein the analyzing the audio input comprises:
processing the audio input using an on-premise processor to perform initial voice-to-text conversion locally;
performing preprocessing of the converted text before communicating with a language model; and
determining interrupt intent based on the preprocessing.

12. The method of claim 8, wherein the analyzing the audio input comprises:
analyzing sentiment through voice characteristics including volume, tone, or speaking rate; and
adjusting interruption sensitivity based on the analyzed sentiment.

13. The method of claim 8, wherein the analyzing the audio input comprises:
categorizing sounds in the audio input as either meaningful interruptions or non-interruptive vocal ticks; and
continuing the AI assistant's speech without interruption in response to detecting a non-interruptive vocal tick.

14. The method of claim 13, wherein the categorizing of the sounds comprises:
updating the user profile with specific vocal patterns specific to the user over time by tracking speaking habits and common vocal expressions;
identifying whether detected sounds match known vocal tick patterns in the user profile; and
using machine learning to detect whether sounds indicate acknowledgment or interruption intent.

15. A non-transitory computer-readable storage medium storing a set of instructions that, when executed by one or more computer processors, causes the one or more computer processors to perform operations, the operations comprising:
receiving audio input during an artificial intelligence (AI) voice interaction between a user and an AI assistant;
analyzing the audio input in real-time to determine whether the audio input represents an intended interruption of the AI assistant's speech;
in response to determining the audio input represents an intended interruption, stopping the AI assistant's speech and tracking what portion of a response was actually spoken; and
maintaining context awareness by storing information about the interrupted response to allow resuming from the point of interruption.

16. The non-transitory computer-readable storage medium of claim 15, wherein the analyzing the audio input comprises:
accessing a user profile containing historical interaction patterns for the user; and
determining whether the audio input matches known vocal patterns associated with intended interruptions for the user based on the historical interaction patterns.

17. The non-transitory computer-readable storage medium of claim 15, wherein the analyzing the audio input comprises:
detecting whether the audio input represents an affirmative acknowledgment rather than an intended interruption; and
continuing the AI assistant's speech without interruption in response to detecting an affirmative acknowledgment.

18. The non-transitory computer-readable storage medium of claim 15, wherein the analyzing the audio input comprises:
processing the audio input using an on-premise processor to perform initial voice-to-text conversion locally;
performing preprocessing of the converted text before communicating with a language model; and
determining interrupt intent based on the preprocessing.

19. The non-transitory computer-readable storage medium of claim 15, wherein the analyzing the audio input comprises:
analyzing sentiment through voice characteristics including volume, tone, or speaking rate; and
adjusting interruption sensitivity based on the analyzed sentiment.

20. The non-transitory computer-readable storage medium of claim 15, wherein the analyzing the audio input comprises:
categorizing sounds in the audio input as either meaningful interruptions or non-interruptive vocal ticks; and
continuing the AI assistant's speech without interruption in response to detecting a non-interruptive vocal tick.
